(19) United States
(12) Patent Application Publication
(10) Pub. No.: US 2026/0327145 A1
(43) Pub. Date: Oct. 22, 2026

(54) RAPID MANUFACTURING OF CARBON-BASED MATERIALS USING FIELD ASSISTED SINTERING TECHNOLOGY

(71) Applicant: CARBON SIC TECHNOLOGIES, INC., Las Vegas, NV (US)

(72) Inventors: Clifford B. Leonard, Las Vegas, NV (US); Tilman C. Voorsanger, Henderson, NV (US); Allan B. Marin, Las Vegas, NV (US)

(21) Appl. No.: 19/649,077

(22) Filed: Apr. 15, 2026

Related U.S. Application Data
(60) Provisional application No. 63/790,641, filed on Apr. 17, 2025.

(51) Int. Cl. B22F 7/08; B22F 3/14; B22F 3/16

(52) U.S. Cl. CPC C04B 35/52; C04B 35/62281; C04B 2235/666

(57) ABSTRACT

Disclosed herein are embodiments of a method of manufacturing carbon-based materials using field assisted sintering technology, otherwise known as spark plasma sintering. A method may include selecting one or more materials, preparing the one or more materials, preforming the one or more materials, loading the one or more materials into a field assisted sintering machine, sintering the loaded materials in the field assisted sintering machine, and/or post-machining the sintered product. In some embodiments, the combined materials may be prepared using a high shear compaction method instead of or in addition to preforming.

### INCORPORATION BY REFERENCE

Any and all applications for which a foreign or domestic priority claim is identified in the Application Data Sheet as filed with the present application are hereby incorporated by reference under 37 CFR 1.57 as if fully set forth herein. This application claims the benefit of U.S. Provisional Application No. 63/790,641 filed on Apr. 17, 2025.

### BACKGROUND

### Field of the Disclosure

Embodiments of the present disclosure relate to devices, apparatuses, and methods for manufacturing carbon-based materials, for example and without limitation, carbon-carbon (C—C) composites, carbon-carbon silicon carbide (C—C—SiC) composites, and graphite, using field assisted sintering technology (FAST), also referred to as spark plasma sintering (SPS).

### Description of the Related Art

Carbon-based materials and components such as, but not limited to, carbon-carbon (C—C) composites, carbon-carbon silicon carbide (C—C—SiC) composites, and graphite are high-performance materials known for their excellent thermal stability and mechanical strength, which can make them very useful in a wide variety of industries, including but not limited to automotive, aerospace, defense, and more.

Despite these wide range of applications, traditional methods of manufacturing carbon-based materials are expensive and time consuming. For example, traditional methods of manufacturing carbon-based materials may include chemical vapor infiltration, polymer infiltration pyrolysis, reactive melt infiltration, or other processes. Using traditional methods, it may take weeks or even months, and several infiltration, thermal, and/or densification cycles, to manufacture carbon-based materials. In addition, traditional methods of manufacturing carbon-based materials often result in composites that exhibit high porosity, usually only achieving 88%-92% of the full density of carbon. This high porosity can lead to accelerated oxidation of the material at high temperatures due to the high degree of oxygen present in the pores of the composite when the component is heated. Additionally, the high porosity can weaken the mechanical properties of the components, reducing performance.

Additionally, traditional methods of manufacturing carbon-based components can result in components having undesired residual materials. For example, when manufacturing C—SiC using traditional methods, there may be residual silicon up to, for example, 8%. This residual silicon may oxidize at, for example, 700 °C, and may melt at, for example, 1,410 °C, which may compromise the mechanical and thermal properties of components having residual silicon. Accordingly, components manufactured using traditional methods may not be suitable for high temperature applications above, for example, 1,200 °C in oxygen.

Current methods of manufacturing carbon-carbon composites often involve using a resin or molding compound which can be converted into carbon with a high char yield, such as phenol formaldehyde. These high char yield resins can be combined with carbon fiber to form a plastic called carbon fiber reinforced plastic (CFRP). The CFRP can then be heated in an inert atmosphere at temperatures above, for example, 1,000 °C, to burn off volatiles, which can thereby form a carbonized body. In order to reduce the porosity of the resulting carbonized body, the carbonized body can be reinfiltrated with more resins using methods such as vacuum assisted resin transfer molding, for example. The reinfiltrated carbonized body can then be heated in an inert atmosphere to be carbonized again, resulting in a denser carbonized body, or a carbonized body with less porosity. These steps, reinfiltrating and carbonizing, may be repeated several times until a desired density, or porosity, is achieved. This entire process can take several months and can be very expensive because of the time and manual labor involved in making the final component. Further, this process can result in carbon-carbon composites having high porosities, which can lead to accelerated oxidation.

Accordingly, improved methods are needed for manufacturing carbon-based components.

### SUMMARY OF SOME EXAMPLE EMBODIMENTS

The devices, systems, and methods described in this disclosure each have several innovative aspects, implementations, or aspects, no single one of which is solely responsible for the desirable attributes disclosed herein.

The present disclosure provides improved methods for manufacturing carbon-based components by implementing field assisted sintering technology (FAST), also known and referred to herein as spark plasma sintering (SPS). Field assisted sintering may involve applying electrical current and/or pressure to heat and densify a formulation, or a combination or mixture of materials, inside of a vacuum chamber. Field assisted sintering may apply pressure and heat by passing electrical current through molds or dies. The electrical current may cause resistive heating to heat the materials from within, as opposed to applying heat only at the outer surface. Advantageously, applying heat using electrical currents may allow the materials to achieve higher temperatures at a significantly higher rate than by heating the materials externally. Field assisted sintering may advantageously allow extremely rapid heating and cooling of the formulation, enabling high density materials to be sintered with ultra-fine, or even nano-sized grain structures.

Carbon-carbon (C—C) composites are composites that include carbon fibers embedded in a carbon matrix and have a wide variety of applications. For example and without limitation, carbon-carbon composites have a wide range of applications in the aerospace, automotive, and defense industries. In the aerospace industry, for example, carbon-carbon composites can be used in brakes, for rocket components, and in other components. In the automotive industry, for example, carbon-carbon composites can be used in brakes, lightweight components, batteries, such as but not limited to electric vehicle batteries, ballistics armor, and in other components. Carbon-carbon composites are used in these applications at least in part because of their high temperature strength, high thermal shock resistance, and low thermal expansion.

Carbon-carbon silicon carbide zirconium diboride (C—C—SiC—ZrB₂) composites are composites that include carbon fibers embedded in a matrix including carbon, silicon carbide, and zirconium diboride. In some embodiments, carbon-based composites can include carbon, carbon fiber, and a wide range of additional materials, including but not limited to ultra high temperature ceramics. For example and without limitation, carbon-based composites can include B₄C, HfC, HfB₂, TiC, TiB₂, and other ultra high temperature ceramic materials. Carbon-based composites may have a wide range of applications, such as but not limited to in the automotive, aerospace, and defense industries. Advantageously, carbon-carbon silicon carbide composites may have strong oxidation resistance properties.

Graphite is a crystalline form of carbon. Graphite can have a wide range of applications, including but not limited to the automotive, aerospace, and defense industries.

As will be described herein, a process for manufacturing carbon-based materials may include selecting one or more materials to include in a formulation. The one or more materials can be milled into a fine powder and mixed. The one or more materials may include pitch, which is a precursor to carbon. The one or more materials may additionally include silicon carbide, which can be used for manufacturing carbon-carbon silicon carbide composites, and/or zirconium diboride, which may help to increase the part's thermal conductivity. The one or more materials may include one or more additives, which may include but are not limited to milled fibers, which may be carbon fibers that have been milled into smaller particle sizes, and/or coked mesophase pitch, which may be mesophase pitch that has already been heat treated to partially or fully carbonize. These additives may advantageously reduce the flow of the pitch during preforming, which can result in less wasted material and/or off-gassing.

In some embodiments, these one or more materials can then be combined with fibers, which may include continuous or discontinuous carbon fibers. Discontinuous carbon fibers may refer to carbon fibers that have been cut or chopped to a length in a range from ⅛ inch or approximately ⅛ inch to 2 inches or approximately 2 inches. Continuous carbon fibers may refer to sheets of carbon fiber that have been cut to desired dimensions for the desired part. When using discontinuous carbon fibers, the carbon fibers can be homogeneously mixed with the one or more materials. When using continuous carbon fibers, the one or more materials can be placed on the top and/or bottom side of the sheet of carbon fiber, and one or more sheets of carbon fiber can be layered on top of the one or more materials, and this layering process can be repeated until desired dimensions are reached. The combined one or more materials and carbon fibers can then be placed into a die and then preformed. Preforming may involve heating the combined materials at 400 °C or approximately 400 °C, or in a range from 350 °C or approximately 350 °C to 450 °C or approximately 450 °C, or from 300 °C or approximately 300 °C to 500 °C or approximately 500 °C, or any value, approximate value, or range of values within the foregoing ranges. Preforming may involve applying pressure to the combined materials at 30 MPa or approximately 30 MPa, or in a range from 20 MPa or approximately 20 MPa to 40 MPa or approximately 40 MPa, or in a range from 10 MPa or approximately 10 MPa to 50 MPa or approximately 50 MPa, or in a range from 5 MPa or approximately 5 MPa to 60 MPa or approximately 60 MPa, or in a range from 0 MPa or approximately 0 MPa to 70 MPa or approximately 70 MPa, or any value, approximate value, or range of values within any of the foregoing ranges.

In some embodiments, in addition or as an alternative to preforming, the one or more materials may be formed into and/or provided as one or more sheets, which may be referred to throughout this disclosure as tape. For example and without limitation, a high shear compaction process can be applied to the one or more materials to form shear tape. Forming shear tape may involve pressing the one or more materials with a binder and then burning off the binder at a temperature of 200 °C or approximately 200 °C, resulting in a flexible sheet of the one or more materials. The tape can then be layered with one or more sheets of continuous fiber and loaded into a die of a field assisted sintering machine. In some embodiments, the one or more sheets (e.g., tape) may include pitch-based tapes, slurry or solvent-based tapes, powder-based or dry fiber tapes, tackified tapes, and/or any other kinds of tape.

After preforming, the resulting preform, and/or the one or more layers of tape and carbon fiber, can then be loaded into a die of a field assisted sintering machine and sintered. Sintering may involve heating the materials at a target temperature of 2,000 °C, or approximately 2,000 °C, with a ramp rate of 20 °C/minute, or approximately 20 °C/minute, and applying pressure of 40 MPa, or approximately 40 MPa, and holding the materials at the target temperature for 60 minutes, or approximately 60 minutes. The sintered part can then be removed from the die and post-machined to final dimensions.

According to one or more of the methods described herein, carbon-carbon composites can be produced having approximately 98%-100% of the density of carbon, for example densities of between 1.9 g/cm³ or approximately 1.9 g/cm³ and 2.2 g/cm³ or approximately 2.2 g/cm³. Additionally, carbon-carbon composites can be produced in as little as a few hours, as opposed to the several weeks or even months using traditional methods. The embodiments disclosed herein can also lead to a significant drop in energy usage to produce these materials, which can, by extension, lower production costs by up to 90% less than traditional methods. In addition, pitch-based carbon precursors can be much cleaner than the materials used in traditional methods for manufacturing carbon-carbon composites, such as phenolic resins, which can carry formaldehyde, a cancer-causing chemical. Advantageously, the embodiments disclosed herein can result in significant reductions in cost and manufacturing times. Additionally, the embodiments disclosed herein can allow for selecting materials and parameters to result in composites having controlled or desired mechanical, thermal, and/or electrical properties.

Any of the steps described herein can be applied to any one of or any combination of the materials disclosed herein and can be performed according to any of the parameters described herein.

In some embodiments, a method for manufacturing a carbon-based component using field assisted sintering technology can include: providing a powder including mesophase pitch and a plurality of milled carbon fibers; combining the powder with a plurality of carbon fibers; creating a preform from the combined powder and plurality of carbon fibers by heating the combined powder and plurality of carbon fibers; loading the preform into a field assisted sintering machine; and sintering, via the field assisted sintering machine, the preform by applying electric current and pressure to the preform to create the carbon-based component, wherein the carbon-based component has a density of at least 90% of a theoretical density.

In some embodiments, the mesophase pitch has a softening point between approximately 300 °C and approximately 400 °C. In some embodiments, the mesophase pitch includes approximately 10% to approximately 35% of a volume of the combined powder and plurality of carbon fibers, the plurality of carbon fibers include approximately 40% to approximately 55% of the volume, and the plurality of milled fibers include approximately 10% to approximately 45% of the volume. In some embodiments, creating the preform includes heating the combined powder and plurality of carbon fibers to a target temperature between approximately 350 °C and approximately 450 °C. In some embodiments, creating the preform includes applying a pressure of between approximately 1 MPa and approximately 20 MPa during heating. In some embodiments, creating the preform includes loading the combined powder and plurality of carbon fibers into a hot press. In some embodiments, sintering the preform includes heating the preform to a target temperature of between approximately 1,800 °C and approximately 2,200 °C. In some embodiments, sintering the preform includes applying a pressure of between approximately 20 MPa and approximately 70 MPa to the preform. In some embodiments, the density is at least 95% of the theoretical density. In some embodiments, the plurality of milled carbon fibers have lengths between approximately 100 microns and 200 microns. In some embodiments, the plurality of carbon fibers include chopped carbon fibers have lengths between approximately 0.125 inches and approximately 2 inches. In some embodiments, the plurality of carbon fibers include unidirectional carbon fiber. In some embodiments, the plurality of carbon fibers include two-dimensional woven carbon fiber. In some embodiments, the plurality of carbon fibers include chopped carbon fibers having lengths between approximately 0.125 inches and approximately 2 inches, and unidirectional carbon fiber. In some embodiments, a method can include applying tape to the preform, and sintering the preform includes sintering the tape and the preform. In some embodiments, the carbon-based component is produced without repeated infiltration and pyrolysis cycles. In some embodiments, the carbon-based component is produced without using phenolic resins. In some embodiments, the powder further includes one or more of silicon carbide and zirconium diboride.

In some embodiments, a method of manufacturing a carbon-based component using field assisted sintering technology can include: providing a powder including mesophase pitch; heating and applying pressure to the powder to create a preform; loading the preform into a field assisted sintering machine; and sintering, via the field assisted sintering machine, the preform by applying electric current and pressure to the preform to create the carbon-based component.

In some embodiments, the carbon-based component has a density of at least 90% of a theoretical density. In some embodiments, the mesophase pitch is at least partially coked. In some embodiments, the mesophase pitch is coked at approximately 800 °C. In some embodiments, the powder includes an average particle size of approximately 1 micron to approximately 50 microns. In some embodiments, creating the preform includes heating the powder to a target temperature between approximately 350 °C and approximately 450 °C. In some embodiments, creating the preform includes applying a pressure of between approximately 1 MPa and approximately 20 MPa during heating. In some embodiments, sintering the preform includes heating the preform to a target temperature of between approximately 2,000 °C and approximately 3,000 °C. In some embodiments, the carbon-based component is produced without repeated infiltration and pyrolysis cycles.

In some embodiments, a carbon-based component can include: a carbon matrix including carbon derived from mesophase pitch; and a plurality of carbon fibers embedded in the carbon matrix, wherein: the carbon matrix includes a plurality of milled carbon fibers having lengths between approximately 100 microns and approximately 200 microns.

In some embodiments, the carbon-based component has a density of at least 90% of a theoretical density. In some embodiments, the plurality of carbon fibers include two-dimensional woven carbon fiber. In some embodiments, the plurality of carbon fibers include unidirectional fiber (e.g., non-woven, where all the carbon fibers run parallel in a single direction). In some embodiments, the plurality of carbon fibers include chopped carbon fibers having lengths between 0.125 inches and 2 inches. In some embodiments, the plurality of carbon fibers include chopped carbon fibers having lengths between approximately 0.125 inches and approximately 2 inches, and unidirectional carbon fiber. In some embodiments, the plurality of carbon fibers include PAN-based fibers. In some embodiments, the plurality of carbon fibers include pitch-based fibers. In some embodiments, the plurality of milled carbon fibers include PAN-based fibers. In some embodiments, the plurality of milled carbon fibers include pitch-based fibers. In some embodiments, the plurality of milled carbon fibers include between approximately 10% and approximately 45% of a volume of the carbon-based component. In some embodiments, the carbon matrix further includes silicon carbide. In some embodiments, the silicon carbide includes between approximately 10% and approximately 50% of a volume of the carbon-based component. In some embodiments, the carbon matrix further includes zirconium diboride. In some embodiments, the density is at least 95% of the theoretical density. In some embodiments, the plurality of carbon fibers include between approximately 20% and approximately 55% of a volume of the carbon-based component.

In some embodiments, a carbon-based component can include: a carbon matrix including carbon derived from mesophase pitch sintered at a target temperature between approximately 2,400 °C and 3,000 °C, wherein: the carbon-based component has a density of at least 90% of a theoretical density.

In some embodiments, the carbon-based component has a degree of graphitization of at least 80%. In some embodiments, the carbon is derived from mesophase pitch coked at between approximately 500 °C and approximately 1,000 °C. In some embodiments, the carbon matrix is derived entirely from mesophase pitch. In some embodiments, the carbon is derived from mesophase pitch having an average particle size between approximately 1 micron and approximately 50 microns. In some embodiments, the density is at least 95% of the theoretical density.

### BRIEF DESCRIPTION OF THE DRAWINGS

FIG. 1A illustrates example carbon-based components manufactured using field assisted sintering technology.

FIG. 1B illustrates an example carbon-based brake rotor manufactured using field assisted sintering technology.

FIG. 2A illustrates an example nozzle manufactured using field assisted sintering technology before post-machining.

FIG. 2B illustrates an example nozzle manufactured using field assisted sintering technology before post-machining.

FIG. 2C illustrates an example nozzle manufactured using field assisted sintering technology before post-machining.

FIG. 2D illustrates an example nozzle manufactured using field assisted sintering technology after post-machining.

FIG. 3 illustrates an example carbon-carbon composite puck manufactured using field assisted sintering technology.

FIG. 4A illustrates an example scanning electron microscope image of a carbon-carbon composite manufactured using field assisted sintering technology.

FIG. 4B illustrates an example scanning electron microscope image of a carbon-carbon composite manufactured using field assisted sintering technology.

FIG. 5A illustrates an example graph comparing manufacturing of carbon-based materials using field assisted sintering technology and traditional methods.

FIG. 5B illustrates an example table comparing manufacturing of carbon-based materials using field assisted sintering technology and other methods.

FIG. 5C illustrates an example comparison of heating in a hot press and a field assisted sintering system.

FIG. 5D illustrates an example time versus temperature graph comparing hot pressing and field assisted sintering.

FIG. 5E illustrates an example table comparing properties of carbon-based materials and other materials.

FIG. 6A illustrates an example process flow for manufacturing carbon-based materials using field assisted sintering technology.

FIG. 6B illustrates an example process for manufacturing carbon-based materials using field assisted sintering technology.

FIG. 6C illustrates an example process for manufacturing carbon-based materials using field assisted sintering technology.

FIG. 6D illustrates an example process for manufacturing carbon-based materials using tape.

FIG. 7 illustrates an example table of formulations for manufacturing carbon-based materials using field assisted sintering technology.

FIG. 8A illustrates an example process for preparing materials for manufacturing carbon-based materials.

FIG. 8B illustrates an example process for preparing materials with continuous fiber layering.

FIG. 8C illustrates an example process flow for preparing materials as tape.

FIG. 9A illustrates example preforms for manufacturing carbon-based materials.

FIG. 9B illustrates an example ring-shaped preform for manufacturing carbon-based materials.

FIG. 9C illustrates an example nozzle preform for manufacturing carbon-based materials.

FIG. 9D illustrates an example carbon-carbon composite preform including continuous carbon fiber.

FIG. 9E illustrates an example carbon-carbon composite preform including discontinuous fibers.

FIG. 9F illustrates an example carbon-carbon silicon carbide composite preform including discontinuous fibers.

FIG. 9G illustrates an example carbon-carbon silicon carbide composite preform including discontinuous fibers.

FIG. 10A illustrates an example field assisted sintering machine.

FIG. 10B illustrates a cross-sectional view of an example field assisted sintering machine.

FIG. 10C illustrates a cross-sectional view of an example field assisted sintering machine.

FIG. 10D illustrates a cross-sectional view of an example field assisted sintering machine.

FIG. 10E illustrates an exploded view of an example die assembly.

FIG. 10F illustrates an example perspective view of the die assembly of FIG. 10E.

FIG. 11A illustrates a graph of example preforming parameters.

FIG. 11B illustrates a graph of example field assisted sintering parameters.

FIG. 11C illustrates example carbon-carbon components manufactured using the preforming parameters and the field assisted sintering parameters of FIGS. 11A and 11B.

### DETAILED DESCRIPTION OF SOME EXAMPLE EMBODIMENTS

Disclosed herein are embodiments of methods for rapidly manufacturing carbon-based materials using field assisted sintering technology, otherwise known as spark plasma sintering. For example and without limitation, the methods of manufacturing disclosed herein can be used to rapidly manufacture carbon-carbon composites, carbon-carbon silicon carbide composites, graphite, or other carbon-based materials. In some embodiments, the components can be manufactured in approximately 1 day. In some embodiments, the powders and carbon fiber can be manufactured into carbon-based components using only one preforming step and one sintering step. The preforming step can include a single thermal cycle and the sintering step can include a single thermal cycle, where a thermal cycle can be a period of heating followed by a period cooling of the component. Processes such as, but not limited to, polymer infiltration and pyrolysis (PIP) and chemical vapor infiltration (CVI) generally require several thermal cycles, which can take days, weeks, or months. According to some of the methods described herein, the components can be produced without repeated infiltration steps. The carbon-based components can be produced without using resins (e.g., without using phenolic resins). The carbon-based components can be produced without using polymer-infiltration and pyrolysis (PIP). The carbon-based components can be produced without using chemical vapor infiltration (CVI).

Advantageously, the embodiments disclosed herein may produce carbon-based materials that are denser than those produced by traditional methods. For example and without limitation, composites formed by the embodiments disclosed herein may have densities that are equal to or greater than 75% of the theoretical density, or equal to or greater than 80% of the theoretical density, or equal to or greater than 85% of the theoretical density, or equal to or greater than 90% of the theoretical density, or equal to or greater than 91% of the theoretical density, or equal to or greater than 92% of the theoretical density, or equal to or greater than 93% of the theoretical density, or equal to or greater than 94% of the theoretical density, or equal to or greater than 95% of the theoretical density, or equal to or greater than 96% of the theoretical density, or equal to or greater than 97% of the theoretical density, or equal to or greater than 98% of the theoretical density, or above 99% of the theoretical density, or equal to or greater than 99.9% of the theoretical density, wherein 100% density is the full theoretical density of the one or more materials. As a result, carbon-based components disclosed by the embodiments disclosed herein can have better oxidation resistance and mechanical properties than those produced by traditional methods.

The embodiments disclosed herein may significantly reduce the energy, time, and cost required to produce carbon-based components. For example and without limitation, the embodiments disclosed herein can reduce the time required to produce carbon-based components from weeks or months to hours. Additionally, the embodiments disclosed herein may produce composites that are safer than those produced by traditional methods because traditional methods commonly rely on phenolic resins, which can carry formaldehyde, a chemical that is known to cause cancer. Advantageously, the embodiments disclosed herein may allow the thermal and electrical properties of final products to be precisely controlled. For example and without limitation, a formulation to be loaded into and heated in a field assisted sintering machine can include materials and proportions that are selected to result in specific thermal and electrical properties. Similarly, parameters, such as but not limited to temperatures, pressures, currents, heating times, and more can be controlled to produce components having specific thermal and electrical properties. Additionally, carbon fiber can be cut, oriented, and/or positioned to provide desired mechanical properties.

In some embodiments, field assisted sintering can be used to manufacture a composite that is 100% carbon based. For example and without limitation, a composite may include carbon fibers and a carbon matrix. In some embodiments, a composite may be 75% or more carbon based. For example and without limitation, a composite may include carbon fibers, a carbon matrix, and other materials, such as but not limited to milled carbon fibers, coked mesophase pitch, silicon carbide, and zirconium diboride. In some embodiments, field assisted sintering can be used to manufacture graphite. For example and without limitation, a formulation may include 100% pitch and may be sintered at high pressures and temperatures using field assisted sintering technology to form graphite.

As will be described herein, a method of manufacturing carbon-based materials using field assisted sintering technology may include, but is not limited to, selecting one or more materials, preparing the one or more materials, preforming the one or more materials according to one or more parameters, loading the one or more materials into a field assisted sintering machine, sintering the loaded materials in the field assisted sintering machine according to one or more parameters, and/or post-machining the sintered product. Alternatively, in some embodiments, the combined materials may be prepared using a high shear compaction method instead of or in addition to preforming, as will be described herein.

The methods disclosed herein can be used to rapidly manufacture components having a variety of shapes, including complex shapes such as but not limited to rocket nozzles, and having a variety of material compositions, such as but not limited to carbon-carbon composites, carbon-carbon silicon carbide composites, and graphite. Advantageously, the methods disclosed herein can be used to manufacture components having superior density and reliability at a fraction of the time and cost of traditional methods.

### Applications and Advantages

Field assisted sintering technology can be used to rapidly manufacture carbon-based materials, such as but not limited to carbon-carbon composites, carbon-carbon silicon carbide composites, and graphite.

Carbon-carbon composites, carbon-carbon silicon carbide composites, graphite, and other carbon-based materials may have a wide range of applications, at least in part due to their density, thermal stability, mechanical strength, and other material properties. For example and without limitation, carbon-based materials can be used in automotive and/or aerospace applications, such as but not limited to brakes, rocket components, batteries, ballistic armor, and more. Carbon-based materials manufactured using field assisted sintering can have a wide range of applications outside of the automotive and aerospace fields as well, such as but not limited to medical devices, energy storage, sports equipment, and more.

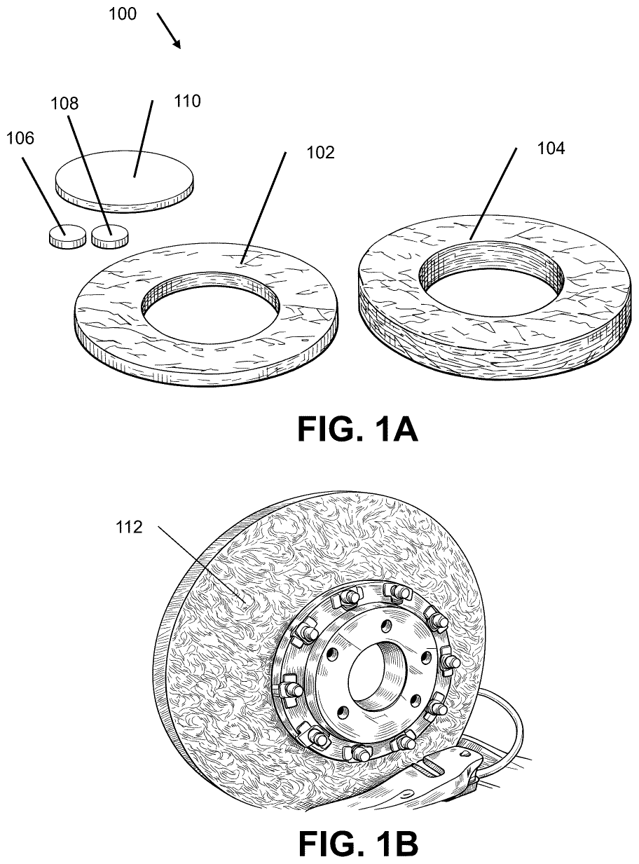

FIGS. 1A and 1B illustrate some examples of carbon-based components 100 that can be manufactured using field assisted sintering. FIG. 1A illustrates a first brake rotor 102, a second brake rotor 104, a first puck 106, a second puck 108, and a third puck 110. FIG. 1B illustrates another example of a carbon-based brake rotor 112 manufactured using field assisted sintering technology.

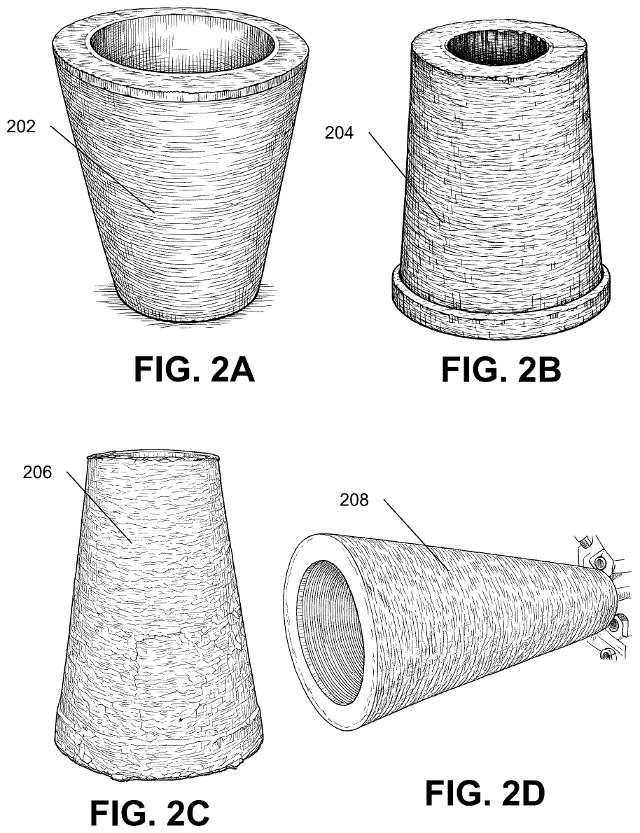

FIGS. 2A-D illustrate examples of nozzles 202, 204, 206, 208 that can be manufactured using field assisted sintering. FIGS. 2A-C illustrate various orientations of the carbon-based nozzles 202, 204, 206 that have been sintered but before post-machining, and FIG. 2D illustrates an example nozzle 208 that has been post-machined.

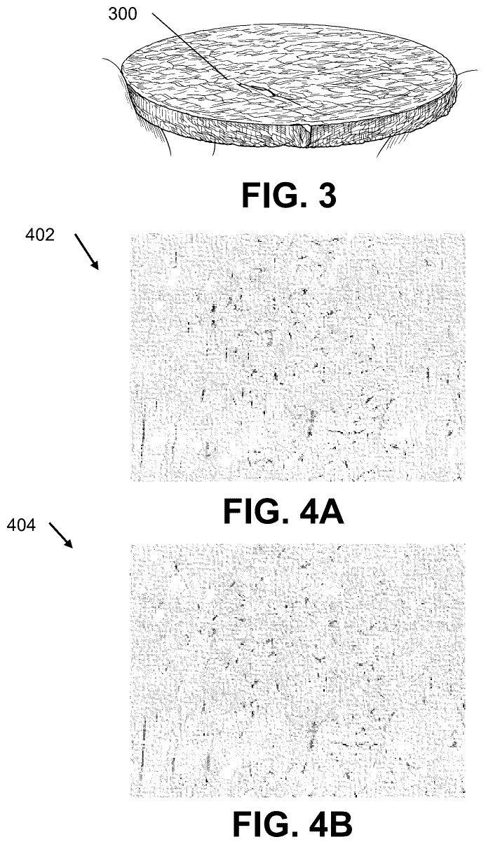

FIG. 3 illustrates an example of a carbon-carbon composite puck 300 manufactured using field assisted sintering. As will be described herein, the carbon-carbon composite puck 300 manufactured using field assisted sintering can include continuous, woven carbon fibers and can be made using mesophase pitch.

FIGS. 4A and 4B illustrate scanning electron microscope (SEM) images 402, 404 of an example carbon-carbon composite manufactured using field assisted sintering. As can be seen in FIGS. 4A and 4B, a carbon-carbon composite manufactured using field assisted sintering technology can have a high density and low porosity, especially as compared to composites manufactured using traditional methods. For example and without limitation, carbon-carbon composites manufactured using field assisted sintering can have a density at or greater than 98% of the density of carbon, or other densities, as described herein.

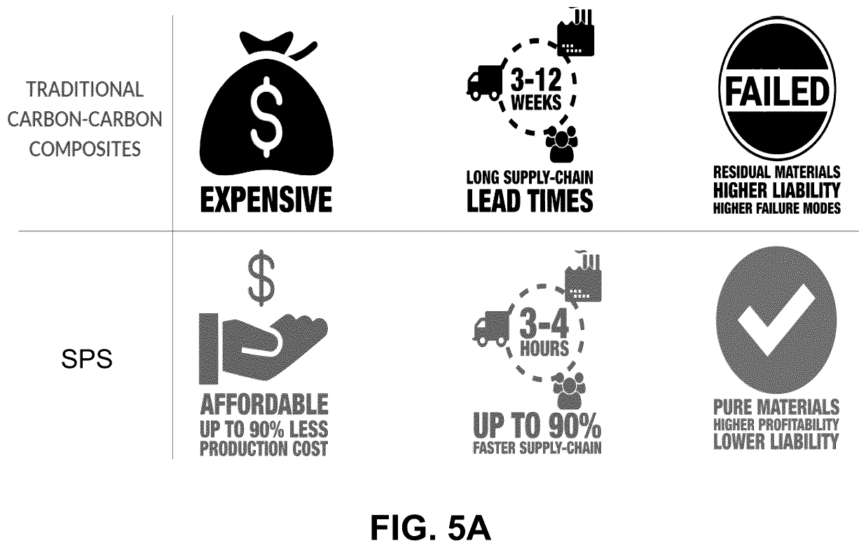

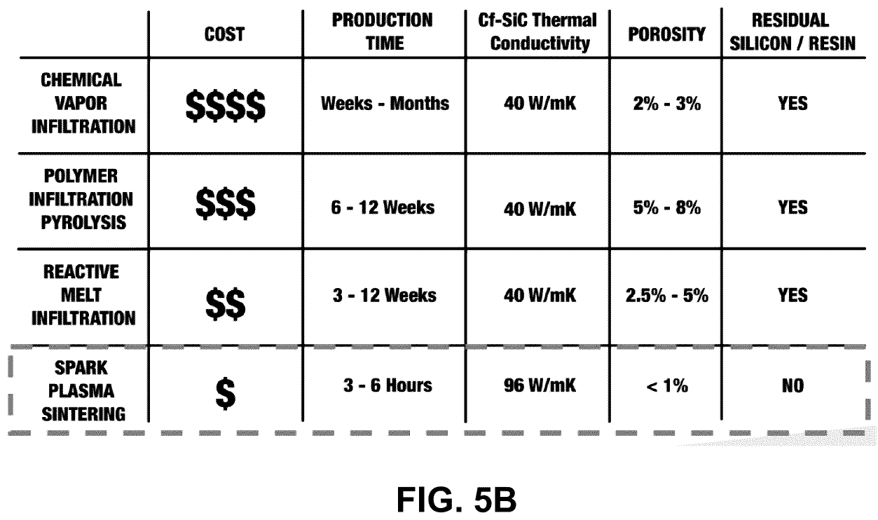

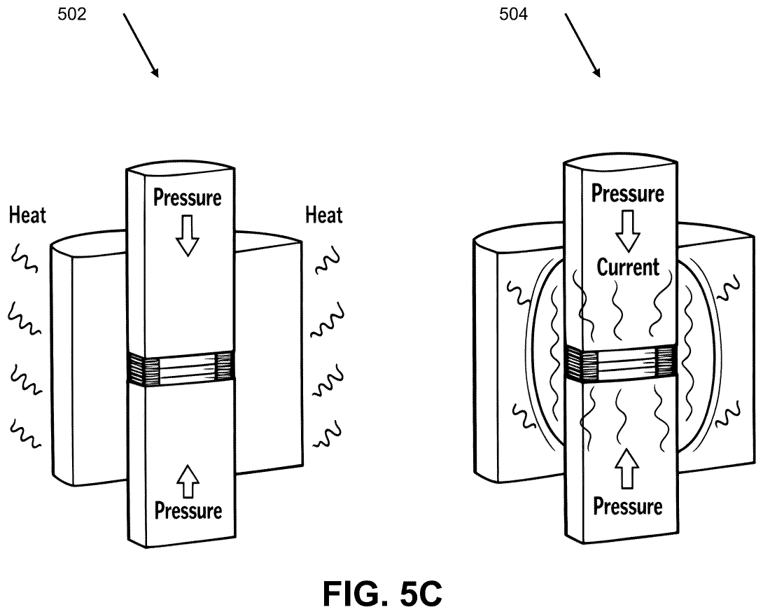

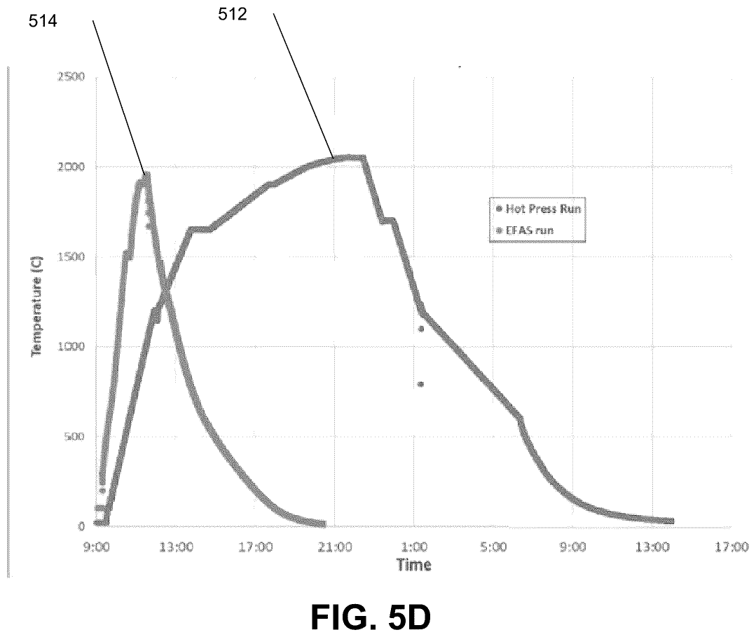

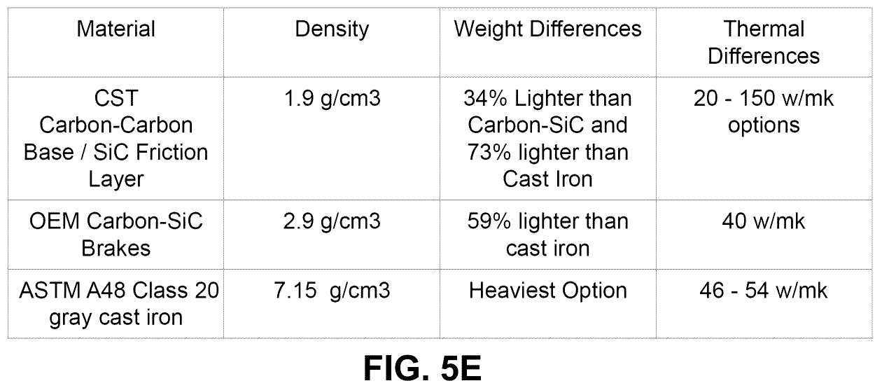

FIGS. 5A-D illustrate the advantages of manufacturing carbon-based materials using field assisted sintering compared to traditional methods. For example and without limitation, as illustrated in FIG. 5A, using field assisted sintering to manufacture carbon-based materials can be significantly cheaper and faster than traditional methods. Additionally, field assisted sintering can produce carbon-based materials having a much higher density than traditional methods, which can result in more reliable components.

FIG. 5B illustrates a table comparing field assisted sintering, otherwise known as spark plasma sintering, to other methods of manufacturing carbon-based materials. As illustrated in FIG. 5B, field assisted sintering can be significantly cheaper and faster, and can produce carbon-based components having higher thermal conductivity, lower porosity, and less residual material.

FIGS. 5C and 5D illustrate a comparison between using a hot press 502 vs. using a field assisted sintering system 504 (also referred to as electric field assisted sintering, or EFAS, in the figure). FIG. 5C shows that hot pressing relies on a heat source external to the die, while field assisted sintering applies current through the die and the one or more materials within the die, which can generate heat in the die and in the one or more materials due to resistive heating. FIG. 5D illustrates a time vs. temperature graph of hot pressing vs. field assisted sintering. Line 512 represents hot pressing, and line 514 represents field assisted sintering. As can be seen in FIG. 5D, field assisted sintering can reach a maximum temperature much quicker than hot pressing, and can cool faster, which can allow carbon-based materials to be manufactured faster using field assisted sintering than using hot pressing.

FIG. 5E illustrates a table comparing the density, weight differences, and thermal differences of a carbon-carbon composite with a silicon carbide friction layer, a carbon silicon carbide composite, and gray cast iron. As can be seen in FIG. 5E, the carbon-carbon composite can have the more favorable properties of the three materials.

Advantageously, field assisted sintering can be used to manufacture parts or components having complex shapes. For example, field assisted sintering may produce shapes that are tall and/or wide. In some embodiments, a method of manufacturing carbon-based materials can include selecting or customizing a custom-machined die, mold, or punch configured to be used in a field assisted sintering machine. For example and without limitation, a method of manufacturing a carbon-based components may include creating or using a die, mold, or punch having a customized profile, such as but not limited to a profile of a brake rotor, a nozzle, a nose tip, or other components. A method of manufacturing a carbon-based component may include post-machining a part or component to have a customized shape, such as the shape of a brake rotor, a nozzle, a nose tip, or another shape.

The materials to be sintered using field assisted sintering can be selected based at least in part on the desired mechanical, thermal and/or electrical properties of the finished part or component. In some embodiments, a method may include calculating a ratio of the one or more materials used in a formulation based at least in part on the desired mechanical, thermal, and/or electrical properties of the finished part or component. In some embodiments, a method may include selecting one or more preforming parameters based at least in part on the desired mechanical, thermal, and/or electrical properties of the finished part or component. In some embodiments, a method may include selecting one or more sintering parameters based at least in part on the desired mechanical, thermal, and/or electrical properties of the finished part or component. In some embodiments, a method may include selecting one or more post-machining parameters based at least in part on the desired mechanical, thermal, and/or electrical properties of the finished part or component.

Advantageously, field assisted sintering can be used to produce carbon-carbon composites having high densities that approach the density of carbon. For example and without limitation, composites formed by the embodiments disclosed herein may have densities that are equal to or greater than 90% density, or equal to or greater than 91% density, or equal to or greater than 92% density, or equal to or greater than 93% density, or equal to or greater than 94% density, or equal to or greater than 95% density, or equal to or greater than 96% density, or equal to or greater than 97% density, or equal to or greater than 98% density, or equal to or greater than 99% density, or equal to or greater than 99.9% density, wherein 100% density is the full theoretical density of the one or more materials.

The theoretical density of the component may be based on the amounts (e.g., percentages by weight, mass, volume, etc.) of the one or more materials in the formulation. The theoretical density of the component may be calculated using the fractions (e.g., mass percentage, volume percentage, etc.) of the one or more materials and the densities of the one or more materials. For example and without limitation, the theoretical density of the component may be calculated using the equation:

$$ρ = {\sum }_{i} {p}_{i} {V}_{i}$$

where ρ is the theoretical density, ρᵢ is the density of each material of the one or more materials, and Vᵢ is the volume fraction (e.g., volume percentage) of the respective material of the one or more materials in the formulation. While volume fraction is used in this equation, mass fraction may be used to determine the theoretical density.

Advantageously, field assisted sintering can be used to produce carbon-based materials having strong oxidation resistance, meaning that the composite can withstand exposure to high temperatures and oxidizing environments without significantly degrading. Advantageously, field assisted sintering can be used to produce carbon-based materials having dissimilar anti-oxidation layers in the same processing cycle, which may save time and costs.

### Process Overview

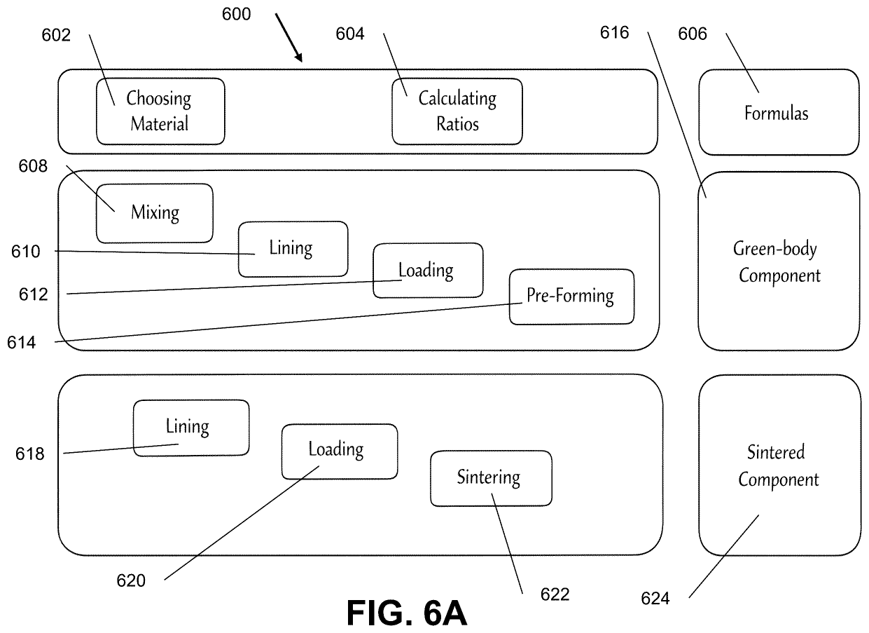

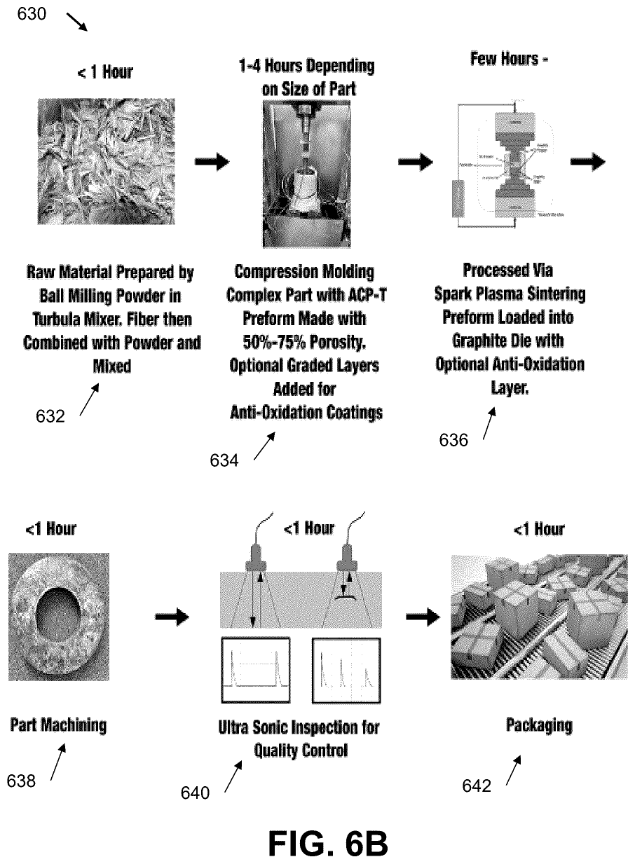

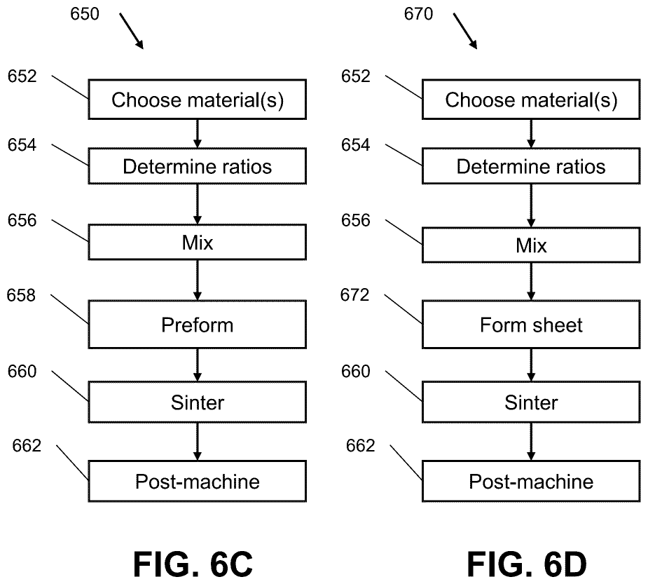

FIGS. 6A-D illustrate example processes for manufacturing carbon-based materials using field assisted sintering technology. The processes described herein can, in some embodiments, produce carbon-based components (e.g., carbon-carbon composites, carbon-based composites, graphite, etc.) in a single thermal and/or densification cycle (e.g., one preforming step, and one sintering step). The processes described herein can produce carbon-based components without multiple infiltration cycles. The processes described herein can produce carbon-based components without using polymer infiltration or pyrolysis. As described in further detail below, the field assisted sintering machine can use uniaxial pressure for impregnation/densification of the one or more materials. As is described in further detail below, in some embodiments, the formulation can include milled fibers and/or coked pitch (e.g., partially or fully coked pitch), which can control (e.g., reduce) the flow of the pitch during preforming and/or sintering, reduce volatile organic compound (VOC) loss, and enable high-density consolidation in a single cycle. Throughout this disclosure, partially coked pitch may refer to pitch that has been processed (e.g., heated) to a degree such that the material can still flow during preforming, but in which the viscosity is increased compared to uncoked pitch. Fully coked pitch may refer to pitch that no longer flows at all during preforming. Coked pitch may refer to partially and/or fully coked pitch.

FIG. 6A illustrates an example process 600 for manufacturing carbon-based materials using field assisted sintering technology. As shown in FIG. 6A, one or more materials can be selected and combined to create a formula. The formula can then be preformed or otherwise prepared to create a green-body component (e.g., which may be referred to throughout this disclosure as a preform). The green-body component can be sintered, using a field assisted sintering machine, to create a sintered component.

As illustrated in FIG. 6A, creating the formula 606 may include choosing one or more materials (e.g., step 602) and calculating or determining the ratios of the one or more materials (e.g., step 604) to be included in the formulation 606. As will be described herein, the one or more materials may include, but are not limited to pitch (e.g., mesophase pitch, isotropic pitch, coked pitch, etc.), fibers (e.g., continuous carbon fibers, discontinuous carbon fibers, milled carbon fibers, etc.), silicon carbide, zirconium diboride, and/or any other materials.

As illustrated in FIG. 6A, forming the green-body component 616 may include mixing the one or more materials in the formulation (e.g., step 608), lining a die for receiving the one or more materials with a foil (e.g., step 610), which may help the materials maintain their dimensions and/or with removing the materials from the die, loading the die and the one or more materials into a preforming machine (e.g., step 612), and/or preforming the one or more materials into the green-body component (e.g., step 614). As will be described herein, in some embodiments, forming the green-body component 616 may involve providing or layering one or more layers of tape, which may include sheets manufactured using high shear compaction, or other methods.

As illustrated in FIG. 6A, creating a sintered component 624 may include lining the die with foil (e.g., step 618) and/or wrapping a green-body component in foil, loading the green-body component into a field assisted sintering machine (e.g., step 620), and sintering the green-body (e.g., step 622) using the field sintering machine. As will be described herein, sintering the green-body component (e.g., step 622) may include passing electric current through the green-body component and applying pressure to the green-body component according to one or more sintering parameters, which may include, but are not limited to, a target temperature of the green-body component, pressure applied to the green body component (e.g., axial pressure, radial pressure, or any other direction), time at temperature, and ramp rate. The sintered component can then be post-machined to achieve desired final dimensions.

FIG. 6B illustrates an example process 630 for manufacturing carbon-based materials using field assisted sintering technology. As will be described herein, at step 632, the one or more materials can be prepared by milling the materials into powder. For example and without limitation, the one or more materials can be milled by ball-milling the one or more materials in a ball mixer. Discontinuous and/or milled fibers can then be combined with the powdered materials and mixed to create a mixture of the one or more materials, which may act as a binder, which can then be combined with the fibers. In some embodiments, this process of preparing and combining the one or more materials may take less than one hour.

At step 634, the mixture of the one or more materials and the fibers may then be compression molded (e.g., using a hot press), which may be referred to as preforming. For example and without limitation, the one or more materials can be preformed until the one or more materials have about 50%-75% porosity. Optional graded layers can be added for anti-oxidation coatings. In some embodiments, compression molding may take between around one and four hours, which may be influenced at least in part by the size of the part.

At step 636, the preform can be processed via field assisted sintering, which can also be referred to as spark plasma sintering. In some embodiments, the preform can be loaded into a die, which can be made of graphite, for example. As will be described herein, an optional anti-oxidation layer can be added to the preform before and/or after sintering. In some embodiments, sintering the preform using field assisted sintering can take around three or four hours.

At step 638, the sintered component can be machined to achieve final dimensions. In some embodiments, machining the sintered component can take around one hour.

At step 640, the final component can be inspected for quality control. For example and without limitation, the part can be inspected using ultra sonic inspection. In some embodiments, inspecting the part may take less than one hour.

At step 642, the final component can be packaged for delivery, which may take less than one hour. As illustrated in FIG. 6B, the total amount of time for manufacturing a carbon-based component using field assisted sintering, from the selection of materials to the packaging of a final product, can take less than 24 hours, which can be significantly faster than traditional methods, which can take days, weeks, or months, for example.

FIG. 6C illustrates an example process 650 for manufacturing carbon-based materials using field assisted sintering technology. As will be described herein, a process for manufacturing carbon-based materials using field assisted sintering technology can include, without limitation, choosing one or more materials (e.g., step 652), determining the ratios of the one or more materials (e.g., step 654), mixing the one or more materials (e.g., step 656), preforming the one or more materials according to one or more parameters (e.g., step 658), sintering the one or more materials according to one or more parameters (e.g., step 660), and/or post-machining the sintered product (e.g., step 662).

FIG. 6D illustrates an example process 670 for manufacturing carbon-based materials using tape. As will be described herein, in some embodiments, one or more of the materials can be formed into tape (e.g., step 672). For example, a high shear compaction process can be used to form the one or more materials into shear tape. In some embodiments, when using tape, a preforming step may not be necessary.

In some embodiments, the one or more materials can be loaded into a die for sintering without first preforming the one or more materials. For example and without limitation, when manufacturing graphite, coked mesophase pitch powder can be loaded directly into a die of a sintering machine for sintering, without first preforming.

### Materials and Formulations

The materials used in the formulation can include one or more of a mesophase or isotropic pitch, carbon fiber, partially or wholly coked pitch, milled carbon fibers, and additional materials, such as but not limited to silicon carbide (SiC), zirconium diboride (ZrB2), boron carbide (B₄C), and/or other materials. Throughout this disclosure, the one or more materials may be referred to as a formulation, and the formulation may include one or any combination of materials described herein.

In some embodiments, a method of manufacturing a carbon-based component may include providing, selecting, identifying, calculating, or using a formulation. A formulation may be a composition and proportion of materials used to create a final product or component. A formulation may refer to a combination of specific materials, the relative amount or weight of each material, and a method of combining the materials.

Throughout this disclosure, proportions of materials used in a formulation can refer to a percentage of volume, mass, weight, or another unit of measurement.

### Pitch

In some embodiments, a formulation may include pitch, which can be a derivative of petroleum or coal tar. Pitch can be a material composed of hydrocarbons and can be produced by distilling carbon-based materials such as petroleum or coal. Pitch can be used as a precursor to forming carbon. The pitch may be made from petroleum, and may be called bitumen or asphalt, as opposed to plant-derived pitch, which is a resin.

In some embodiments, a formulation may include isotropic phase pitch, which can be pitch having a molecular structure that is uniform in all directions. In some embodiments, a formulation may include mesophase pitch, which can be pitch that has been heat treated to develop liquid-crystalline regions and exhibit anisotropic properties.

Isotropic or mesophase pitch can be used to act as a binder, which can be a material or substance used to hold together the components of a composite material. Isotropic phase or mesophase pitch may be selected or included in a formulation to achieve one or more desired specific mechanical, electrical, and/or thermal properties of a final product or component. In some embodiments, pitch may be the only material in the formulation, for example and without limitation, when manufacturing graphite.

The pitch may be a solid, powdered material at room temperature. For example and without limitation, the pitch may be referred to as pitch powder. As will be described herein, the pitch can be heat and/or pressure treated to achieve desired material properties before sintering. As heat and/or pressure is increasingly applied to pitch, pitch can transition through different phases, including but not limited to an isotropic phase, mesophase, partial coking, full coking, and eventually graphitization. In an isotropic phase, pitch may have a disordered structure and exhibit isotropic properties. Pitch may transition into a mesophase around 350 °C to 450 °C. In a mesophase, liquid-crystalline regions may begin to form and the pitch may exhibit anisotropic properties. Pitch may begin to coke around 450 °C to 650 °C. Coking may be a process in which the pitch becomes a solid, carbon-rich material, which may be referred to as coke. During coking, the pitch may have a more solid structure and volatile materials may escape. As the pitch becomes fully coked, most or all of the volatile components may be burned off, and the material may have a solid structure. During graphitization, the carbon atoms may become organized in a highly ordered, crystalline graphite structure. As will be described herein, pitch can be heat and/or pressure treated to exhibit various material properties that may be advantageous for an SPS or FAST process.

The mesophase pitch can be a high-viscosity paste-like substance (e.g., 2.3*10⁸ Pa*s, or approximately 20 billion times more viscous than water). The mesophase pitch can be solid or effectively a solid at room temperature, rather than a flowable resin. In some embodiments, the mesophase pitch can have a softening point that is greater than 300 °C or approximately 300 °C, or greater than 320 °C or approximately 320 °C, or greater than 340 °C or approximately 340 °C, or greater than 360 °C or approximately 360 °C, or greater than 380 °C or approximately 380 °C. In some embodiments, the mesophase pitch can have a softening point that is in a range from 340 °C or approximately 340 °C to 360 °C or approximately 360 °C, or from 320 °C or approximately 320 °C to 380 °C or approximately 380 °C, or from 300 °C or approximately 300 °C to 400 °C or approximately 400 °C, or any value, approximate value, or range of values within the foregoing ranges.

Fibers-Discontinuous and/or Continuous

In some embodiments, a formulation may include fiber. For example and without limitation, the formulation may include carbon fiber. The carbon fiber may be derived from pitch or from polyacrylonitrile (PAN). Pitch or PAN-based fibers can be selected for desired material properties of the finished product. For example and without limitation, PAN-based fibers may exhibit a lower modulus of elasticity, meaning that they may stretch more before failure. Discontinuous fibers can include fibers that have been cut in a range from 0.125 inches or approximately 0.125 inches in length to 2 inches or approximately 2 inches in length, or any value, approximate value, or range of values within any of the foregoing ranges. In some embodiments, discontinuous fibers can include milled fibers, which can be fibers that have been milled to a powder, as will be described herein.

Carbon fiber may be included as discontinuous or continuous. Discontinuous fibers may include carbon fibers that have been chopped into shorter, discontinuous lengths. For example and without limitation, discontinuous fibers can be fibers having a length of 1 inch or approximately 1 inch, or in a range from ⅛ inch or approximately ⅛ inch to 2 inches or approximately 2 inches. Continuous carbon fiber may include longer carbon fibers, which may be woven or otherwise formed into two-dimensional sheets of carbon fiber. When using continuous carbon fiber, one or more sheets of continuous carbon fiber can be cut, stacked, and/or arranged to create a desired shape. As will be described herein, one or more layers of binder (e.g., pitch and/or other materials) can be applied between one or more sheets of continuous carbon fiber. Continuous carbon fibers can include unidirectional laminates and/or two-directional laminates. Any of the formulations described herein can include only discontinuous fibers, only continuous fibers, or a hybrid of some continuous fibers and some discontinuous fibers. In some embodiments, the formulation may include only continuous fibers and milled fibers, and may not include any fibers having lengths of 1 inch or approximately 1 inch, or in a range from ⅛ inch or approximately ⅛ inch to 2 inches or approximately 2 inches.

### Milled Fiber

In some embodiments, a formulation may include milled fiber. Milled fiber may be a fiber, for example and without limitation, carbon fiber, that is milled, chopped, or ground into smaller particles or components. For example and without limitation, milled fibers can include fibers that have been milled to particles having particle sizes (e.g., average lengths) of 150 microns or approximately 150 microns, or from 100 microns or approximately 100 microns to 200 microns or approximately 200 microns, or from 1 micron or approximately 1 micron to 500 microns or approximately 500 microns, or any value, approximate value, or range of values within the foregoing ranges. The addition of milled fiber may help reduce the flow of pitch during preforming and/or sintering, and/or reduce off-gassing. Flow, as described herein, can refer to a material's tendency to move or deform. Flow can result in material flashing during preforming, which can result in a loss of material, and can also lead to off-gassing. Off-gassing can refer to the release of volatile substances from the material when the material is preformed or sintered. Off-gassing can result in increased levels of porosity and can disrupt the sintering environment. The milled fiber can control (e.g., reduce) pitch flow during migration, reduce matrix migration, reduce off-gassing, and enable higher and more uniform densities.

### Coked Pitch

In some embodiments, a formulation may include coked pitch. Coked pitch may refer to pitch that has undergone a heat treatment such that the pitch has partially or fully coked, which can mean that the pitch includes coke, a carbon-rich solid residue. Heating the pitch may remove volatile components, such as but not limited to hydrogen, oxygen, and/or nitrogen. Coked pitch can include coked mesophase pitch or coked isotropic pitch. Coked mesophase pitch can refer to mesophase pitch that has been coked, and coked isotropic pitch can refer to isotropic phase pitch that has been coked. The addition of coked pitch may advantageously reduce the flow of pitch during preforming and sintering, which may reduce flashing and/or off-gassing.

### Additional Materials

The formulation may include additional materials. For example and without limitation, additional materials may include silicon carbide (SiC), zirconium diboride (ZrB₂), and/or boron carbide (B₄C). The addition of SiC can be used to form a C—C—SiC composite. The addition of ZrB₂ can be used in part to raise the part's thermal conductivity.

Additional materials may include one or more ultra high temperature ceramics which may include, without limitation, TiC, B₄C, SiC, ZrC, TaC, WC, MoB2, TiB2, ZrB2, TaB2. Additional materials can include ultra high temperature ceramics, such as but not limited to B₄C, HfC, HfB₂, TiC, TiB₂.

One or more additional materials can be used to provide an anti-oxidation layer. For example and without limitation, additional materials can be used to provide an outer layer that is more resistant to oxidation than underlying materials. For example and without limitation, carbon-carbon composites may oxidize at relatively lower temperatures, and adding an anti-oxidation layer may make the component more resistant to oxidation. In some embodiments, there may be one or more outer layers of additional material, or the additional materials may be evenly distributed throughout the component.

### Example Formulations

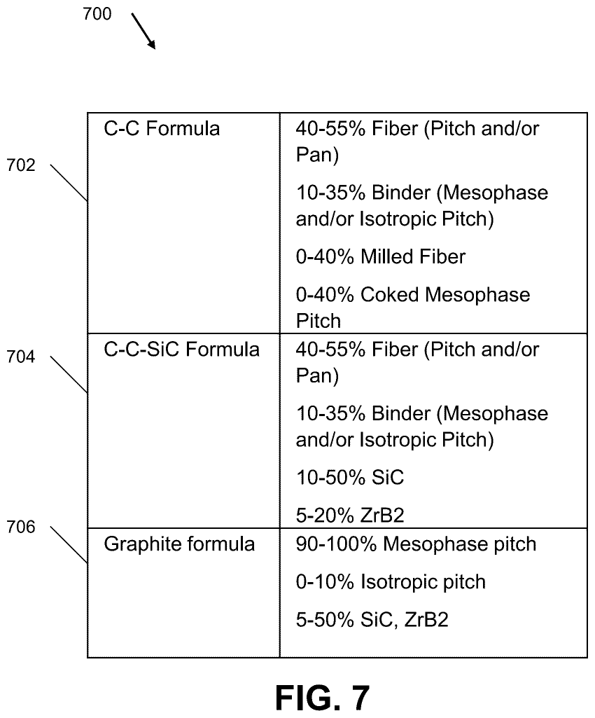

FIG. 7 illustrates a table 700 of example formulations, including but not limited to formulations 702 for carbon-carbon (C—C) composites, formulations 704 for carbon-carbon silicon carbide composites (C—C—SiC, and/or C—C—SiC—ZrB₂) composites, and/or formulations 706 for graphite.

### Carbon-Carbon (C—C) Composite Formulation

A formulation 702 for manufacturing a carbon-carbon composite may include 50% carbon fiber or approximately 50% carbon fiber, or in a range from 45% or approximately 45% to 55% or approximately 55%, or from 40% or approximately 40% to 60% or approximately 60%, or of any value, approximate value, or range of values within any of the foregoing ranges. Carbon fibers can be discontinuous or continuous and can be derived from pitch or PAN.

The formulation 702 for manufacturing a carbon-carbon composite may include 30% or approximately 30% pitch, or in a range from 25% or approximately 25% to 35% or approximately 35%, or from 20% or approximately 20% to 40% or approximately 40%, or from 15% or approximately 15% to 45% or approximately 45%, or from 10% or approximately 10% to 50% or approximately 50%, or from 5% or approximately 5% to 55% or approximately 55%, or of any value, approximate value, or range of values within any of the foregoing ranges. Pitch can be mesophase and/or isotropic.

The formulation 702 for manufacturing a carbon-carbon composite may include 20% milled fiber or approximately 20% milled fiber, or in a range from 15% or approximately 15% to 25% or approximately 25%, or from 10% or approximately 10% to 30% or approximately 30%, or from 5% or approximately 5% to 35% or approximately 35%, or from 0% or approximately 0% to 40% or approximately 40%, or of any value, approximate value, or range of values within any of the foregoing ranges.

The formulation 702 for manufacturing a carbon-carbon composite may include 20% coked pitch or approximately 20% coked pitch, or in a range from 15% or approximately 15% to 25% or approximately 25%, or from 10% or approximately 10% to 30% or approximately 30%, or from 5% or approximately 5% to 35% or approximately 35%, or from 0% or approximately 0% to 40% or approximately 40%, or of any value, approximate value, or range of values within any of the foregoing ranges. Coked pitch can be coked mesophase pitch or coked isotropic pitch.

### Carbon-Carbon Silicon Carbide (C—C—SiC) Composite Formulation

A formulation 704 for manufacturing a C—C—SiC composite may include 50% carbon fiber or approximately 50% carbon fiber, or in a range from 45% or approximately 45% to 55% or approximately 55%, or from 40% or approximately 40% to 60% or approximately 60%, or of any value, approximate value, or range of values within any of the foregoing ranges. Carbon fibers can be discontinuous or continuous and can be derived from pitch or PAN.

The formulation 704 for manufacturing a C—C—SiC composite may include 30% or approximately 30% pitch, or in a range from 25% or approximately 25% to 35% or approximately 35%, or from 20% or approximately 20% to 40% or approximately 40%, or from 15% or approximately 15% to 45% or approximately 45%, or from 10% or approximately 10% to 50% or approximately 50%, or from 5% or approximately 5% to 55% or approximately 55%, or of any value, approximate value, or range of values within any of the foregoing ranges. Pitch can be mesophase and/or isotropic.

The formulation 704 for manufacturing a C—C—SiC composite may include 30% SiC or approximately 30% SiC, or in a range from 25% or approximately 25% to 35% or approximately 35%, or from 20% or approximately 20% to 40% or approximately 40%, or from 15% or approximately 15% to 45% or approximately 45%, or from 10% or approximately 10% to 50% or approximately 50%, or of any value, approximate value, or range of values within any of the foregoing ranges.

The formulation 704 for manufacturing a C—C—SiC composite may include 10% ZrB2 or approximately 10% ZrB2, or in a range from 5% or approximately 5% to 15% or approximately 15%, or from 0% or approximately 0% to 20% or approximately 20%, or of any value, approximate value, or range of values within any of the foregoing ranges.

While this example formulation includes SiC and ZrB2, another example formulation can alternatively include one or more of coked mesophase pitch, milled fibers, TiC, B₄C, SiC, ZrC, TaC, WC, MoB₂, TiB2, ZrB2, TaB2, HfC, and/or HfB₂.

### Graphite Formulation

A formulation 706 for manufacturing graphite may include 100% pitch. Pitch can be mesophase pitch and/or isotropic pitch. The pitch can be coked pitch, which can be coked mesophase pitch or coked isotropic pitch. For example and without limitation, the pitch can be heated at 600 °C or approximately 600 °C to be coked, or in a range from 550 °C or approximately 550 °C to 650 °C or approximately 650 °C, or from 500 °C or approximately 500 °C to 700 °C or approximately 700 °C, or from 450 °C or approximately 450 °C to 750 °C or approximately 750 °C, or from 400 °C or approximately 400 °C to 800 °C or approximately 800 °C or greater than 800 °C, or of any value, approximate value, or range of values within any of the foregoing ranges.

The formulation 706 for manufacturing graphite may include mesophase pitch and isotropic pitch. The isotropic pitch can be heated at 90 °C or approximately 90 °C, or in a range from 80 °C or approximately 80 °C to 100 °C or approximately 100 °C, or in a range from 70 °C or approximately 70 °C to 110 °C or approximately 110 °C. In some embodiments, the formulation 706 may include 100% mesophase pitch or 100% isotropic pitch. In some embodiments, the formulation 706 may include 95% mesophase pitch and/or 5% isotropic pitch. In some embodiments, the formulation 706 may include 90% mesophase pitch and/or 10% isotropic pitch. In some embodiments, the formulation 706 may include 85% mesophase pitch and/or 15% isotropic pitch. In some embodiments, the formulation 706 may include 80% mesophase pitch and/or 20% isotropic pitch. In some embodiments, the formulation 706 may include 75% mesophase pitch and/or 25% isotropic pitch. In some embodiments, the formulation 706 may include 70% mesophase pitch and/or 30% isotropic pitch. In some embodiments, the formulation 706 may include 65% mesophase pitch and/or 35% isotropic pitch. In some embodiments, the formulation 706 may include 60% mesophase pitch and/or 40% isotropic pitch. In some embodiments, the formulation 706 may include 55% mesophase pitch and/or 45% isotropic pitch. In some embodiments, the formulation 706 may include 50% mesophase pitch and/or 50% isotropic pitch. In some embodiments, the formulation 706 may include 45% mesophase pitch and/or 55% isotropic pitch. In some embodiments, the formulation 706 may include 40% mesophase pitch and/or 60% isotropic pitch. In some embodiments, the formulation 706 may include 35% mesophase pitch and/or 65% isotropic pitch. In some embodiments, the formulation 706 may include 30% mesophase pitch and/or 70% isotropic pitch. In some embodiments, the formulation 706 may include 25% mesophase pitch and/or 75% isotropic pitch. In some embodiments, the formulation 706 may include 20% mesophase pitch and/or 80% isotropic pitch. In some embodiments, the formulation 706 may include 15% mesophase pitch and/or 85% isotropic pitch. In some embodiments, the formulation 706 may include 10% mesophase pitch and/or 90% isotropic pitch. In some embodiments, the formulation 706 may include 5% mesophase pitch and/or 95% isotropic pitch.

In some embodiments, the formulation 706 for manufacturing graphite can include one or more of TiC, B4C, SiC, ZrC, TaC, WC, MoB2, TiB2, ZrB2, TaB2, HfC, and/or HfB₂ in the proportions in the table, or in any value, approximate value, or range of values within the provided range.

While FIG. 7 illustrates example percentile ranges for each of the materials included, these percentages are not limiting. The amount of each material in the formulation can be less than or exceed the percentiles illustrated. The illustrated percentiles may refer to percentage by mass, volume, weight, or another measurement. In creating a formulation for a carbon-based material, any of the materials described herein can be selected or combined in any ratio or amount.

### Preparing Materials

The determined or selected materials can then be prepared for preforming and/or sintering. This may include milling the one or more materials into smaller particles, mixing the one or more materials together, and/or combining the materials with fibers. Raw materials may be weighed out to their respective ratios for a target density and volume required to fill a cavity of a tooling die in production.

### Milling

In some embodiments, the one or more materials may be milled to smaller particle or grain sizes. In some embodiments, one or more materials may be milled into a powder, which may involve reducing a material to smaller particles. For example and without limitation, the one or more materials may be milled until the particles have particle sizes (e.g., average lengths) of 150 microns or approximately 150 microns, or from 100 microns or approximately 100 microns to 200 microns or approximately 200 microns, or from 1 micron or approximately 1 micron to 500 microns or approximately 500 microns, or any value, approximate value, or range of values within the foregoing ranges. In some embodiments, materials may be milled such that particles have diameters less than 1 micron, such as in the nanometers. In some embodiments, materials may have particles with diameters greater than 10 microns. Milling may include ball milling, cryomilling, or another method of milling. In some embodiments, tungsten carbide ball mills can be used. Milling the one or more materials may include milling each of the one or more materials separately. Milling the one or more materials may include milling the one or more powders in combination or simultaneously with one or more of the other materials. Any of the materials described herein may be milled to achieve finer grain sizes, such as but not limited to pitch, fibers, SiC, ZrB2, B₄C, etc.

### Mixing

In some embodiments, a method of manufacturing a carbon-based material can include mixing one or more materials. Mixing can involve homogenizing a blend of powder and fiber together. In some embodiments, the one or more materials can be mixed in a tumbler mixer, or in another mixing machine. In some embodiments, mixing the one or more materials in a tumbler mixer or another mixing machine may be for 60 minutes or approximately 60 minutes, or in a range from 30 minutes or approximately 30 minutes to 90 minutes or approximately 90 minutes, or from 0 minutes or approximately 0 minutes to 120 minutes or approximately 120 minutes, or from 0 minutes or approximately 0 minutes to 180 minutes or approximately 180 minutes. In some embodiments, mixing the one or more materials in a tumbler mixer or another mixing machine may be for a period of time less than 30 minutes or more than 180 minutes.

During mixing, one or more grinding media may be included with the one or more materials in the tumbler mixer or mixing machine, which may help prevent agglomeration. For example and without limitation, a method may include adding one or more abrasive balls, such as but not limited to silicon carbide or tungsten, in the mixing machine with the one or more materials. In some embodiments, a method may include removing the grinding media from the mixing machine. A turbula mixer may be configured to move in the x-, y-, and z-axis and to mix materials at various speeds. The mixer may be configured to create a zero-gravity atmosphere which may allow the materials with a low and high density to homogenously mix in a short period.

Combining with Fibers

The one or more materials can be combined with fibers, which can be discontinuous or continuous. When using discontinuous carbon fibers, the powdered materials may be mixed with the discontinuous fibers, which may allow the one or more materials to coat the carbon fibers. For example and without limitation, chopped carbon fibers can be added to the one or more materials in the mixing machine. In some embodiments, a method may include mixing the fiber with the one or more materials for a period of time in a range from 2 minutes or approximately 2 minutes to 10 minutes or approximately 10 minutes. In some embodiments, a method may include mixing the fiber with the one or more materials for fewer than 2 minutes or more than 10 minutes.

When using continuous carbon fiber, a method of manufacturing a carbon-based component may include providing a two-dimensional laminate or woven sheet of carbon fiber and applying the one or more materials to one or both sides of the sheet. For example and without limitation, a method may include applying a layer of pitch and/or other materials to the two-dimensional laminate or woven carbon fiber. One or more continuous sheets of carbon fiber can then be layered onto the layer of pitch and/or other materials, and the process of layering continuous sheets of carbon fiber and the one or more mixed materials can be repeated until the desired dimensions are reached.

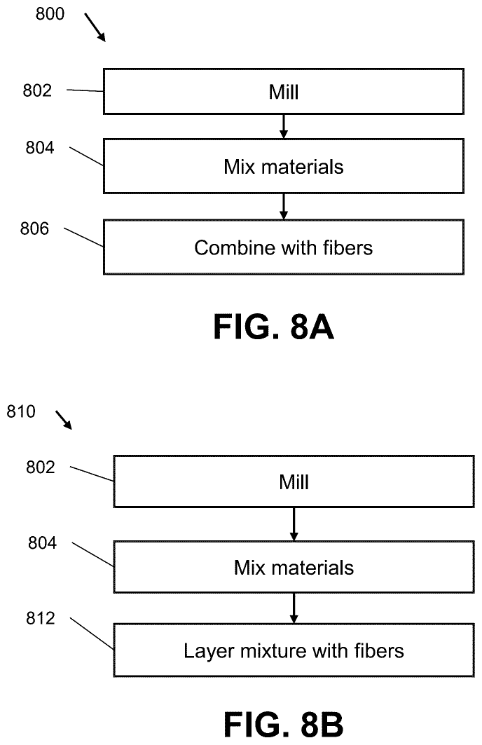

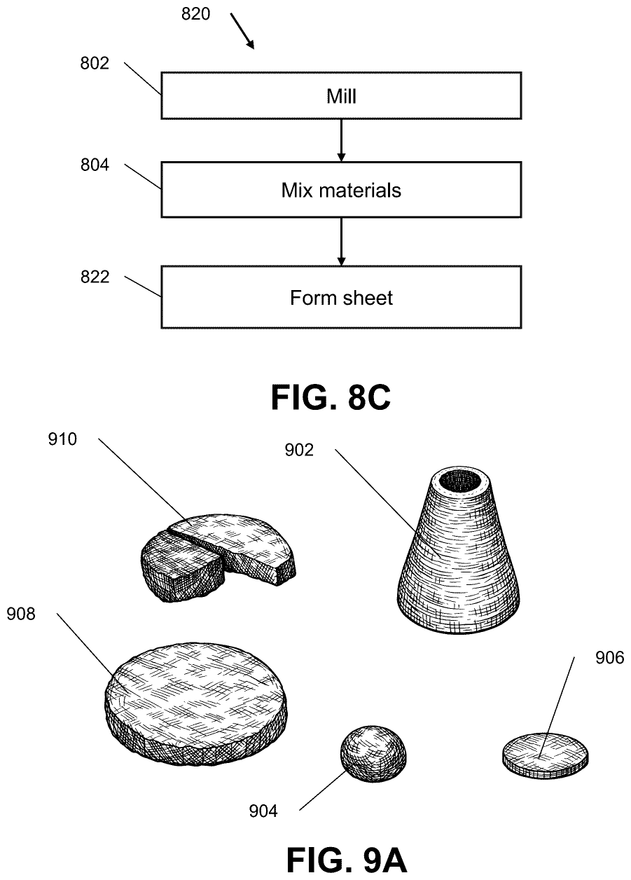

FIG. 8A illustrates an example process 800 for preparing materials. At step 802, the one or more materials can be milled, separately or individually, into smaller particle sizes. Milling can be performed via ball milling, cryo-milling, or through another milling method. At step 804, the one or more materials can be mixed. Mixing can occur for a predetermined amount of time and can be performed using a mixing machine. One or more abrasive balls, which may include silicon carbide and/or tungsten, can be added to help prevent agglomeration. At step 806, the one or more abrasive balls can be removed, and fiber can be added to the mixture. The one or more materials and the fiber can then be mixed again for a predetermined amount of time.

FIG. 8B illustrates an example process 810 for preparing materials. Steps 802 and 804 of FIG. 8B may be similar or identical to the those of FIG. 8A (e.g., milling and/or mixing the one or more materials). At step 812, the one or more materials can be layered with one or more sheets of continuous fiber. For example and without limitation, the one or more materials can be placed on one or both sides of a sheet of woven carbon fiber. After the mixture is applied to one or both sides of the sheet of woven carbon fiber, another sheet of woven carbon fiber can be placed on top of the one or more materials, and this layering process can be repeated until desired dimensions are achieved.

FIG. 8C illustrates an example process 820 for preparing materials. Steps 802 and 804 of FIG. 8C may be similar or identical to those of FIG. 8A and/or FIG. 8B. At step 822, the one or more materials can be formed into one or more sheets, which may be referred to throughout this disclosure as tape. The tape can include any binder-based preform. The tape can include any fiber preform held together by a binder prior to densification, regardless of chemistry. For example and without limitation, the one or more materials can be pressed into a high shear compaction sheet, as will be described below. In this method, the one or more materials can be pressed into shear tape using a high shear compaction method, and a binder may be included, which may help hold the materials together. The binder may be configured to burn off partially or completely, which may leave only the dry powders in a high shear compaction sheet, also referred to herein as shear tape. For example and without limitation, the binder may be configured to burn off at 200 °C or approximately 200 °C, or in a range from 150 °C or approximately 150 °C to 250 °C or approximately 250 °C, or from 100 °C or approximately 100 °C to 300 °C or approximately 300 °C. The binder may include, without limitation, a thermoplastic and/or a polymer. The high shear compaction sheet, which may also be referred to as shear tape, may be flexible, which may make the sheet suitable for laying up in complex shapes before sintering. In some embodiments, the one or more sheets (e.g., tape) may include pitch-based tapes, slurry or solvent-based tapes, powder-based or dry fiber tapes, tackified tapes, and/or any other kinds of tape.

### Lining the Die

In some embodiments, a method of manufacturing carbon-based materials may include lining a die. A die may be a mold configured to hold a formulation or one or more materials during a preforming or a field assisted sintering process and may be used to apply pressure and/or electrical current to the formulation or one or more materials. The die may be made of graphite, steel, carbon-carbon, silicon carbide, or another material.

Lining a die may include cutting a lining material or a foil to a diameter and width corresponding to a die. The foil may be a thin sheet placed between a formulation or one or more materials and a die. Lining the die may involve cutting a foil to a specified distance thickness and count of foil as specified in the drafting callouts of the manufactured dies. The foil can have a thickness of 0.03 inches or approximately 0.03 inches, or from 0.02 inches or approximately 0.02 inches to 0.04 inches or approximately 0.04 inches, or from 0.01 inches or approximately 0.01 inches to 0.05 inches or approximately 0.05 inches, or any value, approximate value, or range of values within the foregoing ranges. For example and without limitation, 0.04 inch thick foil may be used for larger components, and 0.02 inch thick foil may be used for smaller components. In some embodiments, the lining may be +/−0.0002″ of the thickness as specified in the drafting callouts of the manufactured die. In some embodiments, the lining may be greater than or less than +/−0.0002″ of the thickness as specified in the drafting callouts of the manufactured die. In some embodiments, the lining may be +/−0.0001″ of the diameter as specified in the drafting callouts of the manufactured die. In some embodiments, the lining may be greater than or less than +/−0.0001″ of the diameter as specified in the drafting callouts of the manufactured die. The foil may be made of graphite, iron, or one or more other materials. Foil may be cut by hand by skilled labor, by drag-knife routing machines, or through another type of machine configured to cut foil.

The foil on a diameter of the die may be locked such that the ends of the foil pressing on each other create a hoop force holding the foil against the wall of the die. Foil in pre-form layups may be designed with larger tolerances and may be designed in a way as to translate to the graphite die without any foil removal. In some embodiments, foil can be wrapped around the one or more materials to hold the one or more materials in desired dimensions. In some embodiments, foil can be wrapped around or lined on the die before loading the one or more materials into the die.

Lining a die can occur before preforming and/or sintering the one or more materials. For example and without limitation, the one or more materials can be wrapped with foil and/or the die can be lined with foil before a preforming step, before a sintering step, neither, or both. Foil can be used to hold the one or more materials in desired dimensions and can make it easier to load/remove the one or more materials from a die.

### Loading the Materials Into the Die

In some embodiments, a method of manufacturing a carbon-based component may include loading the one or more materials into a die, which may then be loaded into a preforming machine and/or a field assisted sintering machine. A preforming machine may be a machine configured to apply heat and/or pressure to the one or more materials to achieve desired material properties before sintering. A field assisted sintering machine may be a machine configured to utilize electrical current to rapidly heat a formulation while simultaneously applying pressure inside of a vacuum chamber.

Loading the one or more materials into a die may be performed with the aid of specially designed material separators. In some embodiments, the one or more materials can be loaded into the die in a star pattern, which may be a specific pattern of loading the formulation that can help create an even distribution of material. In some embodiments, loading a formulation into the die may include introducing extenders onto the die to increase an effective material carrying capacity of the die. The size of the extender may be selected based at least in part on a predicted tap density ratio of a formulation or one or more materials when the formulation or one or more materials are loaded and subject to a specified amount of force. A tap density ratio may be a ratio of the formulation's current, compacted density to its theoretical maximum density if completely compacted. An amount of force applied can be, for example and without limitation, 1 to 2 tons of force. In some embodiments, the specified amount of force can be, for example, 0.1 to 1 tons of force. In some embodiments, the specified amount of force can be, for example, 2 to 3 tons of force. In some embodiments, the specified amount of force can be, for example, 3 to 4 tons of force. In some embodiments, the specified amount of force can be, for example, more than 4 tons of force. In some embodiments, intermediary pressure (by hand or by hydraulic press) may be used to load additional material. After pressure is applied to the loaded material, the extenders can be removed. In some embodiments, a locking mechanism may be used to access internal extenders.

### Preforming

In some embodiments, a method of manufacturing a carbon-based component may include preforming the formulation of the one or more materials. Preforming may be a process of applying heat and/or pressure to the formulation in a die before sintering the formulation. Preforming may help ensure that a material has a desired density, shape, material distribution, and/or other material properties before the sintering process. Preforming may be performed using a preforming machine (e.g., a hot press). A preforming machine may be configured to introduce heat and/or pressure to a die containing the loaded formulation or materials. Preforming a formulation may include loading the formulation into a die, and heat and/or pressure can be applied to the die containing the loaded formulation via the preforming machine.

During preforming, the one or more materials can be heated at 400 °C or at approximately 400 °C, or in a range from 350 °C or approximately 350 °C to 450 °C or approximately 450 °C, or from 300 °C or approximately 300 °C to 500 °C or approximately 500 °C, or at any value, approximate value, or range of values within any of the foregoing ranges.

During preforming, pressure can be applied to the one more materials at 30 MPa or approximately 30 MPa, or in a range from 25 MPa or approximately 25 MPa to 35 MPa or approximately 35 MPa, or from 20 MPa or approximately 20 MPa to 40 MPa or approximately 40 MPa, or from 15 MPa or approximately 15 MPa to 45 MPa or approximately 45 MPa, or from 10 MPa or approximately 10 MPa to 50 MPa or approximately 50 MPa, or from 5 MPa or approximately 5 MPa to 55 MPa or approximately 55 MPa, or from 0 MPa or approximately 0 MPa to 60 MPa or approximately 60 MPa, or from 0 MPa or approximately 0 MPa to 70 MPa or approximately 70 MPa, or of any value, approximate value, or range of values within any of the foregoing ranges. During preforming, heat and/or pressure can be applied until a desired tap density has been achieved. Tap density may refer to a ratio of the mass of the powder to the volume occupied by the powder. A tap density ratio may be a ratio of the current density of the formulation to the desired density of the final product or component. For example and without limitation, the one or more materials can be preformed until the one or more materials have a tap density of 1.3× or approximately 1.3× of the desired final dimensions, or in a range from 1.2× or approximately 1.2× to 1.4× or approximately 1.4×, or of any value, approximate value, or range of values within any of the foregoing ranges. In some embodiments, especially for larger components, the one or more materials can be preformed until the one or more materials have a tap density of 1.8× or approximately 1.8× of the desired final dimensions, or in a range from 1.7× or approximately 1.7× to 1.9× or approximately 1.9×, or of any value, approximate value, or range of values within any of the foregoing ranges. In some embodiments, especially for formulations having lower mesophase contents (for example and without limitation, 5-10%), the one or more materials can be preformed until the one or more materials have a tap density of 2.0× or approximately 2.0× the desired final dimensions, or in a range from 1.9× or approximately 1.9× to 2.1× or approximately 2.1×, or from 1.8× or approximately 1.8× to 2.2× or approximately 2.2×, or of any value, approximate value, or range of values within any of the foregoing ranges.

In some embodiments, preforming can be for a specified period of time. In some embodiments, preforming can be for 120 minutes or approximately 120 minutes, or in a range from 90 minutes or approximately 90 minutes to 150 minutes or approximately 150 minutes, or from 60 minutes or approximately 60 minutes to 180 minutes or approximately 180 minutes, or from 30 minutes or approximately 30 minutes to 210 minutes or approximately 210 minutes, or from 0 minutes or approximately 0 minutes to 240 minutes or approximately 240 minutes, or of any value, approximate value, or range of values within any of the foregoing ranges.

During preforming, the pitch may melt and/or burn off volatiles, which may leave behind a binder holding the materials together as a semi-stable preform. Semi-stable can mean that the one or more materials may be stable provided they are subjected to no more than small or minor disturbances. For example and without limitation, semi-stable may mean that the preform can hold a shape at room temperature but is not fully solidified and/or carbonized. Semi-stable may mean that the preform may change dimensions due to exposure to liquid or temperature changes. For example and without limitation, the preform may oxidize if exposed to temperatures above 450 °C, and the combined materials may become damaged or lose their desired dimensions if exposed to liquid, which is in part why the preform may be considered semi-stable. In some embodiments, the preform may be considered semi-stable because it includes mesophase pitch that has been heated to 300 °C or approximately 300 °C, or in a range from 250 °C or approximately 250 °C to 350 °C or approximately 350 °C, or of any value, approximate value, or range of values within any of the foregoing ranges. At or around these temperatures, the mesophase pitch may begin to melt, and may help to hold the one or more other materials together. Accordingly, the preform may be considered semi-stable because the mesophase pitch may hold the one or more materials together, but the mesophase pitch may not be fully solidified and/or carbonized. In some embodiments, a preform may be considered semi-stable if one or more powders, such as but not limited to coked mesophase pitch, milled fibers, SiC, and/or ZrB₂ are combined with the pitch because the dry powders may restrict or limit the ability of the pitch to hold the fibers and/or any other materials together. For example and without limitation, the one or more materials (e.g., coked mesophase pitch, milled fibers, SiC, ZrB₂, and/or any other ultra high temperature ceramics) combined with the pitch may not melt during preforming, which may limit the ability of the combined pitch and other materials to hold the carbon fiber together, resulting in a semi-stable preform.

In some embodiments, burning off of volatiles may occur at the same time (e.g., during the same process) as preforming. In some embodiments, burning off of volatiles may be a distinct step from preforming. For example and without limitation, after preforming, the materials can be further heated to burn off volatiles. In some embodiments, the materials can be heated to burn off volatiles before preforming.

In some embodiments, burning off of volatiles can involve heating at a temperature of 500 °C or approximately 500 °C, or in a range from 450 °C or approximately 450 °C to 550 °C or approximately 550 °C, or from 400 °C or approximately 400 °C to 600 °C or approximately 600 °C, or from 350 °C or approximately 350 °C to 650 °C or approximately 650 °C, or from 300 °C or approximately 300 °C to 700 °C or approximately 700 °C, or at temperatures greater than 700 °C, or of any value, approximate value, or range of values within any of the foregoing ranges.

After preforming, a formulation may be referred to as a preform or a green body component. In some embodiments, preforming a formulation may include loading the formulation into a preforming machine and activating the preforming machine. In some embodiments, preforming a formulation may include removing the formulation, or the preform, or the green body component, from the preforming machine.

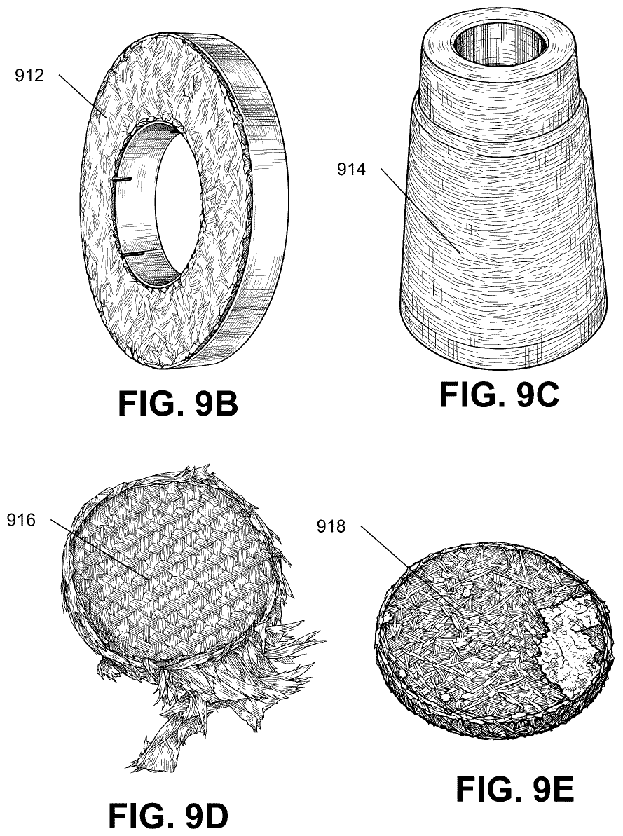

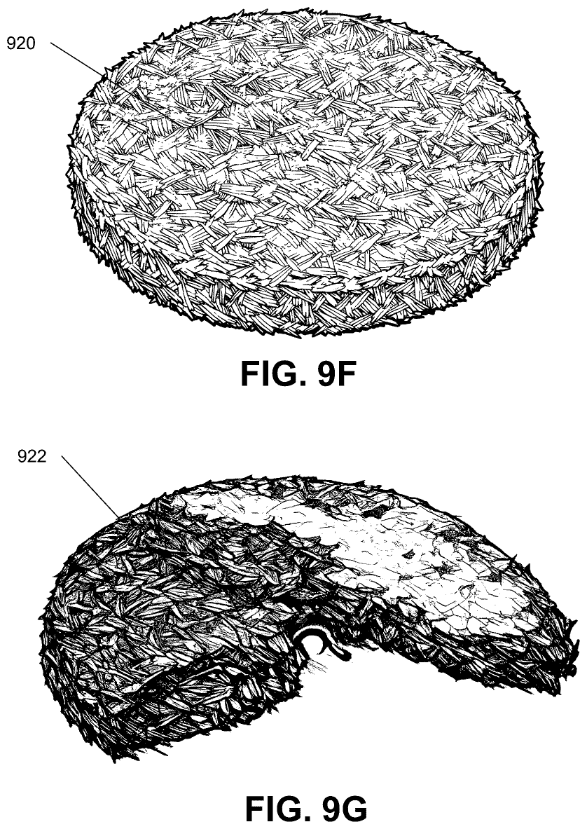

FIGS. 9A-G illustrate examples of preforms having a variety of shapes and material compositions. FIG. 9A illustrates five examples of preforms: a nozzle shape 902 with the foil still on, a two-inch sample 904 of a carbon-carbon composite including discontinuous fibers, a two-inch sample of a carbon-carbon composite including continuous fibers 906, a six-inch sample 908 of a carbon-carbon silicon carbide composite including discontinuous fibers and made from isotropic pitch, and a six-inch sample 910 of a carbon-carbon silicon carbide composite including discontinuous fibers and made from mesophase pitch.

FIG. 9B illustrates an example ring-shaped preform 912 comprising mesophase pitch partially heated at 350 °C and discontinuous carbon fibers. FIG. 9C illustrates an example of a nozzle 914 with the foil still on. FIG. 9D illustrates a sample carbon-carbon composite 916 including continuous carbon fiber. In this example, the continuous carbon fiber includes twill weave carbon fiber. FIG. 9E illustrates a sample carbon-carbon composite 918 including discontinuous fibers. In this example, the discontinuous fibers include chopped carbon fibers. FIG. 9F illustrates a sample carbon-carbon silicon carbide composite 920 including discontinuous fibers. In this example, the formulation before preforming included isotropic pitch, silicon carbide and zirconium diboride. FIG. 9G illustrates a sample carbon-carbon silicon carbide composite 922 including discontinuous fibers. In this example, the formulation included silicon carbide, mesophase pitch, and chopped carbon fibers.

The sample preforms illustrated in FIGS. 9A-9G are not limiting. Preforms can be formed using any combination of the materials described herein, and using any combination of preforming parameters described herein.

### Tape

In some embodiments, sheets of materials, which may be referred to as tape, may be used. For example and without limitation, tape comprising one or more of pitch, SiC, ZrB₂, and/or any other materials may be used. For example, pitch used in tape may include mesophase pitch that has been heated at 600 °C or at approximately 600 °C to partially or fully coke. In some embodiments, tape can include fiber, which may include discontinuous and/or milled carbon fiber. The tape can include high shear compaction sheets, pitch-based tapes, slurry or solvent-based tapes, powder-based or dry fiber tapes, tackified tapes, and/or any other kinds of tape. The tape can include any of the materials described herein (e.g., mesophase and/or isotropic pitch, carbon fiber, partially or wholly coked pitch, milled carbon fibers, silicon carbide, zirconium diboride, boron carbide, and/or other materials).

Advantageously, the use of tape may allow or make it easier for one or more layers of one or more materials to be added to complex shapes. For example and without limitation, it may be difficult to add one or more anti-oxidation layers to a cone-like shape, such as for a rocket nozzle, using loose powders. Sheets of materials may allow anti-oxidation layers containing, without limitation, silicon carbide and/or zirconium diboride, to be added to complex shapes like rocket nozzles. These one or more layers may be advantageous for parts that may be exposed to high temperatures and may be prone to oxidation, such as but not limited to carbon-carbon composites.

In some embodiments, one or more powdered materials can be mixed homogeneously together and pressed into a high shear compaction sheet containing a resin that can help hold all the materials together. The high shear compaction sheet may exhibit flexible properties which may be suitable for laying up complex shapes without the need for loose powders. The high shear compaction resin may burn off at lower temperatures (e.g., 100 °C, 150 °C, 200 °C, 250 °C, 300 °C, etc.) which may leave little to no residue behind and only the desired materials. Advantageously, these high shear compaction sheets can be molded without any flow of the material required.

The binder used in any of the kinds of tape may include a thermoplastic and/or a polymer, and may off-gas carbon monoxide (CO), carbon dioxide (CO₂), hydrogen gas (H₂), and/or small aromatic hydrocarbons when the binder is burned off. In some embodiments, the burn-off of the binder can occur in an oven and may include an oxygenated atmosphere. The binder, which may be a plastic-based or other type of binder, may be configured to burn off when heat is applied, which may leave only the desired materials. For example and without limitation, the binder may be configured to burn off at temperatures of 200 °C or approximately 200 °C, or in a range from 150 °C or approximately 150 °C to 250 °C or approximately 250 °C, or in a range from 100 °C or approximately 100 °C to 300 °C or approximately 300 °C, or of any value, approximate value, or range of values within any of the foregoing ranges.

Advantageously, these one or more tapes can be molded without any flow of the material required. In some embodiments, if tape is used, preforming may no longer be necessary and the one or more materials may be placed directly into a die for sintering. In some embodiments, one or more layers of tape can be layered with one or more layers of carbon fibers, such as but not limited to two-dimensional woven sheets of carbon fibers. Advantageously, these one or more layers can easily be formed into complex shapes for sintering, such as into a cone or a nozzle. Tape may allow an anti-oxidation layer to be easily applied to carbon-carbon composites having complex shapes, such as a cone or a rocket nozzle. In some embodiments, one or more layers of tape can be applied to a carbon-carbon composite, and the combined materials can be sintered in a field assisted sintering machine to create an anti-oxidation layer.

In some embodiments, the tape can be stamped with a roughing pattern, which may occur during manufacturing of the tape. The tape at the boundaries of dissimilar materials may be stamped to help hold the dissimilar layers together or prevent them from sliding relative to each other.

In some embodiments, the tape may be sintered onto components that have already been sintered. For example and without limitation, one or more sheets of tape may be applied to a carbon-carbon composite and loaded into a die of a field assisted sintering machine for sintering. Similarly, one or more layers of tape may be applied to C—C—SiC composites and/or graphite for sintering. Tape may be used to apply one or more anti-oxidation layers.

### Sintering

In some embodiments, a method of manufacturing a carbon-based component may include sintering the formulation, the preform, or the green body component. Sintering may involve placing the formulation, preform, or green body component into a chamber of a field assisted sintering machine, also referred to as a spark plasma sintering machine. A field assisted sintering machine may be configured to apply electrical current and/or pressure to the formulation, preform, or green-body component for sintering. In some embodiments, the pressure may be axial pressure, or may be pressure in another direction, such as a radial direction.

### Field Assisted Sintering Technology (FAST)/Spark Plasma Sintering (SPS) Machine

Field assisted sintering technology (FAST), otherwise known as spark plasma sintering (SPS), may refer to a process in which electrical current and pressure are applied to materials within a die to sinter the materials. The electrical current can cause resistive heating in the materials.

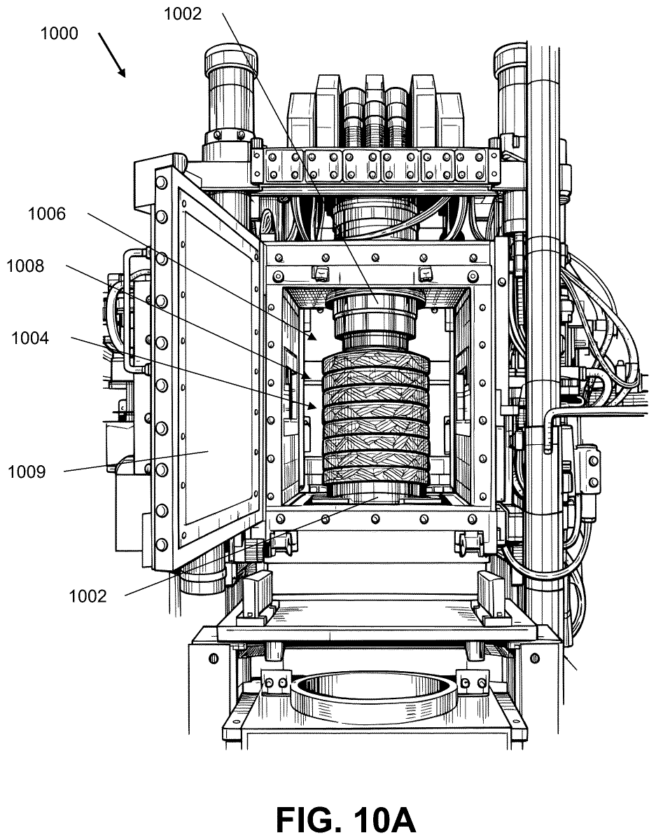

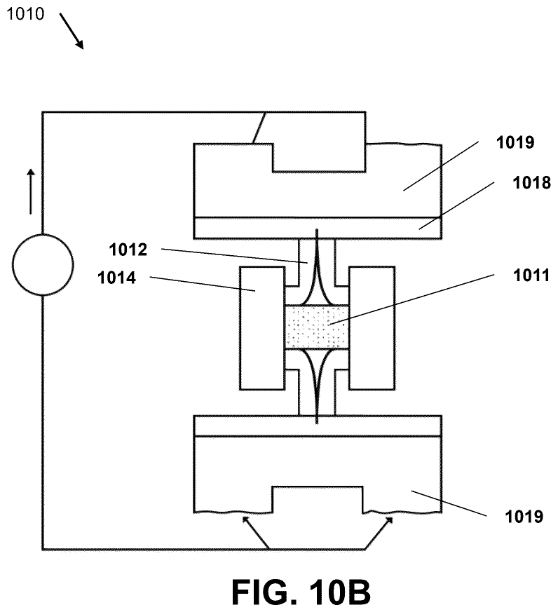

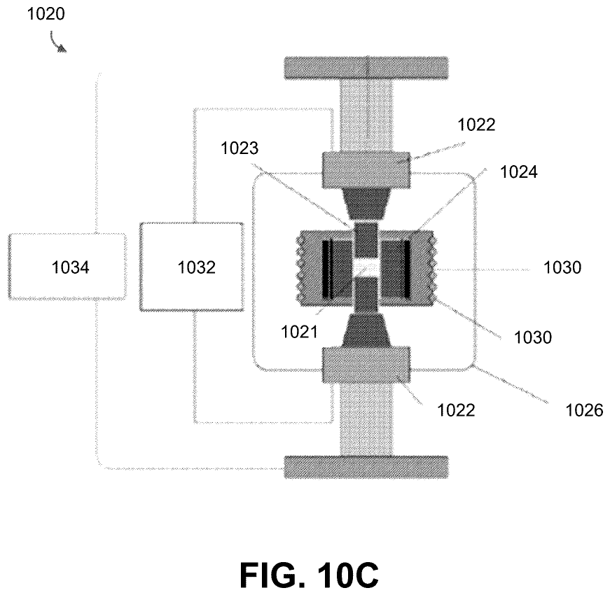

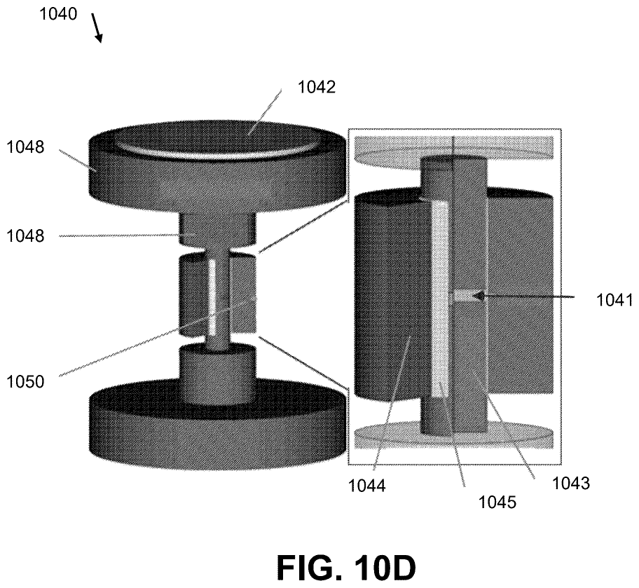

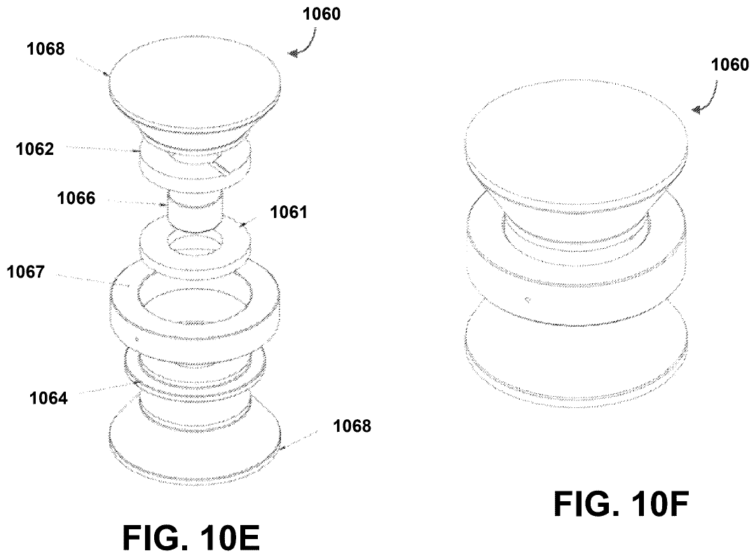

FIG. 10A illustrates an example of a FAST/SPS machine 1000. A FAST machine 1000 may include one or more electrodes 1002 configured to conduct electricity through one or more dies 1004 containing one or more materials to be sintered. A die 1004 may also be referred to as a mold. The die 1004 can include a cavity within a die for receiving materials. The die 1004 may be one or more components for holding the one or more materials in a desired shape or configuration during preforming and/or sintering. The die 1004 may be made of steel, carbon-carbon composite, graphite, and/or other materials. The die 1004 can have a predetermined electrical resistivity and/or coefficient of thermal expansion, and may be selected on the basis of either or both. For example and without limitation, if the one or more materials to be sintered have a lower electrical resistivity, then a die 1004 having a higher electrical resistivity may be preferred, as heat will be generated within the one or more materials due to their higher electrical resistance. If the one or more materials have a lower electrical resistance, then a die 1004 with a higher electrical resistance may be preferred so that the electrical resistance of the die will generate heat. In some embodiments, the die 1004 may be selected to match or have a similar coefficient of thermal expansion as that of the one or more materials to be sintered. If the coefficient of thermal expansion of the die 1004 is different from that of the one or more materials to be sintered, then the die 1004 and the one or more materials within the die 1004 may expand and/or contract at different rates when heated/cooled, which can lead to breakage of the die 1004, the machine 1000, or the final product. In some embodiments, the die 1004 and/or the materials to be sintered can be lined with a foil to help maintain the dimensions of the materials and/or to facilitate removal of the sample after the sintering process is complete.

The FAST/SPS machine 1000 may include one or more vacuum chambers 1006. The vacuum chamber 1006 can be configured to receive one or more dies 1004. The vacuum chamber 1006 may include one or more doors 1009 for accessing the inside of the vacuum chamber 1006, and may include one or more windows for viewing the inside of the vacuum chamber 1006 while the FAST/SPS machine is operating.

In some embodiments, the FAST/SPS machine 1000 can include one or more spacers 1008 for applying pressure to the one or more materials contained in the die. The spacers 1008 may contact the die 1004 to apply pressure to the die, and consequently, the materials within the die 1004.

The FAST/SPS machine 1000 may be configured to conduct electricity through the die 1004 containing the one or more materials via the electrodes 1002, spacers 1008, and die 1004. For example and without limitation, electrical current can be a pulsed DC current. The amount of electrical current delivered to the materials can be based at least in part on a target heating temperature and a resistance of the materials and/or the die 1004. The FAST/SPS machine 1000 may include a feedback loop to measure a temperature of the materials, the die 1004, and/or an inside of the chamber 1006, and adjust the current based on the desired temperature.

The FAST/SPS machine 1000 may include one or more sensors for measuring a temperature, pressure, or other parameters of the materials, the die 1004, and/or the chamber 1006. For example and without limitation, the vacuum chamber 1006 may include a temperature sensor and a pressure sensor to measure a temperature and pressure within the vacuum chamber 1006.

The FAST/SPS machine 1000 may include a controller. The controller may be in communication with the punches, the doors, the sensors, or any other components of the FAST/SPS machine 1000. In some embodiments, the machine 1000 may be in communication with one or more mobile devices through a network. The controller may be contained within the housing or located remotely from the machine 1000, and in communication with the machine 1000 through the network, such as the Internet, a wide area network (WAN), a local area network (LAN), etc. Thus, the controller may be a micro-control unit embedded in the machine 1000, a separate standalone remote controller or computer, a cloud-based application, or other appropriate device or combination of devices. The controller may include one or more CPU or processor boards, computer displays, touch screens and interface hardware. The communication or transmitting may be wired or wireless (or a hybrid combination thereof) and may be achieved through a Wi-Fi system, Bluetooth® wireless technology, Ethernet, router, cellular communications, satellite communications or the like. In various embodiments, the controller can be a laptop, computer or mobile device such as a tablet or mobile phone. The controller may be configured to control any of the parameters of the FAST/SPS machine 1000 described herein, such as but not limited to target temperature, temperature, amount of electrical current passing through the materials, ramp rate, pressure, time at temperature, etc.

The FAST/SPS machine 1000 may include a user interface. The user interface may include one or more displays and one or more inputs. The one or more displays may be configured to display information about the FAST/SPS machine 1000, process, and/or any operating parameters. The one or more inputs can be used to change any of the operating parameters of the machine 1000. In some embodiments, the user interface can be a screen (e.g., a touch screen) and can include one or more buttons (e.g., touch screen, analog buttons, dials, etc.). In some embodiments, the user interface may be on a separate computer, mobile device, web application, etc.

In some embodiments, sintering may involve creating a vacuum in the chamber 1006 of the field assisted sintering machine 1000. Creating a vacuum may involve using a pump to remove air from the chamber 1006. Creating a vacuum may involve adding or pumping an inert gas into the chamber 1006 of the field assisted sintering machine 1000. For example and without limitation, creating a vacuum may involve adding or pumping argon gas or nitrogen gas into the chamber 1006 before or while the formula, preform, or green body is in the chamber 1006. In some embodiments, creating a vacuum may involve reducing a pressure within the chamber 1006 to 10\hat{ }(−1) or 10\hat{ }(−3) Torr. In some embodiments, creating a vacuum may involve reducing a pressure within the chamber 1006 to 10\hat{ }(−3) to 10\hat{ }(−6) Torr.

FIGS. 10A-E illustrate examples of field assisted sintering machines. FIG. 10A illustrates an example field assisted sintering machine 1000 with an opened door 1009, revealing the vacuum chamber 1006. Inside the vacuum chamber 1006, the die 1004 can be loaded into the machine between one or more punches and/or spacers 1008. The die 1004 can be configured to hold a green-body component or the one or more materials. The one or more punches can be configured to pass electrical current through the green-body component and/or the one or more materials via the die 1004 and to apply pressure to the green-body component and/or the one or more materials via the die 1004. One or more spacers 1008 can be added to hold the die 1004 at a desired position within the vacuum chamber.

FIG. 10B illustrates an example cross-sectional view of a field assisted sintering machine 1010. The field assisted sintering machine 1010 may include a die 1014. The die 1014 may include graphite and may be configured to hold and conduct electricity to the green-body component or the one or more materials 1011. In this example, the die 1014 may include a cylinder, although it is appreciated that the die 1014 can take many shapes, such as but not limited to a cone, a rectangular prism, or any other shape.

A field assisted sintering machine 1010 may include one or more plungers 1012, which may also be referred to as punches and/or electrodes. The one or more plungers 1012 may be placed into and on either side of the one or more materials 1011 within the die 1014. The one or more plungers 1012 may be configured to conduct electrical current through the one or more materials 1011 within the die 1014.

A field assisted sintering machine 1010 may include one or more spacers 1018. The one or more spacers 1018 may be configured to hold the die 1014 and the plungers 1012 in place in the machine 1010, and may be configured to conduct current and/or heat between the machine 1010 and the plungers 1012, the die 1014, and the machine 1010. In some embodiments, the spacers 1018 may include graphite. In some embodiments, the die 1014, the plungers 1012, and/or the spacers 1018 may include carbon-carbon composites, carbon-carbon silicon carbide composites, graphite, another carbon-based material, or any other material. It may be advantageous to select a material for the die 1014, plungers 1012, and spacers 1018 that have a similar coefficient of thermal expansion to the one or more materials 1011 being sintered.

A field assisted sintering machine 1010 may include one or more rams 1019. The rams 1019 may be configured to conduct electricity and apply pressure to the spacers 1018 and/or the plungers 1012. In some embodiments, the one or more rams 1019 may include steel, graphite, carbon-carbon composite, carbon-carbon silicon carbide composite, another carbon-based material, or any other material. A field assisted sintering machine 1010 may include a power supply configured to create a voltage differential such that current passes through the one or more materials 1011 within the die 1014.

FIG. 10C illustrates a cross-sectional view of an example spark plasma sintering system 1020. In some embodiments, the SPS system 1020 can include one or more electrodes 1022 configured to conduct electricity through a mold 1024. In some embodiments, the mold 1024 can include a graphite material, a carbon-carbon composite, a carbon-carbon silicon carbide composite, or another material. Other materials can be utilized, as further described below. In some embodiments, the one or more electrodes 1022 can be configured to create an electrical current 1032 therebetween. In some embodiments, electrical current 1032 can be a pulsed DC current. In some embodiments, an SPS system 1020 can further include a plurality of pistons 1023 for applying force to a formulation 1021 or a green-body component contained in the mold 1024. In some embodiments, the plurality of pistons 1023 can be powered through a hydraulic system 1034. In some embodiments, the SPS system 1020 can include a vacuum chamber 1026. In some embodiments, an SPS system 1020 can optionally include a heating coil near or around the mold 1024. In some embodiments, the temperature of the SPS system 1020 can be measured at various locations using one or more temperature sensors 1030. In some embodiments, the one or more temperature sensors 1030 can include, for example, thermocouples and/or pyrometers.

FIG. 10D illustrates a cross-section view of an example spark plasma sintering system 1040. In some embodiments, components of the field assisted sintering system 1040 can include one or more electrodes 1042, which can be made of an electrically conductive material, such as but not limited to molybdenum (Mo). In some embodiments, one or more spacers 1048 can be implemented between the one or more electrodes 1042 and the sample 1041. In some embodiments, the plurality of spacers 1048 can each include a different geometry and a predetermined electrical resistivity. In some embodiments, the spacers 1048 can each have the same or similar geometry and predetermined electrical resistivity. The die 1044 can be made of graphite or other materials described above. In some embodiments, the die 1044 can be lined with a foil 1045, which may facilitate removal of the sample 1041 after the SPS process has been completed. Components can include one or more punches 1043 to facilitate the application of axial force to sample 1041 during the SPS process. As with the die 1044, the one or more punches 1043 can include steel, graphite, or other materials, as described above. In some embodiments, the temperature of the SPS system 1020 can be measured at various locations using one or more temperature sensors 1050. In some embodiments, the one or more temperature sensors 1050 can include, for example, thermocouples and/or pyrometers.

FIGS. 10E-F are exploded and perspective views, respectively, of example embodiments of components for use in an SPS system for the manufacture of carbon fiber reinforced ceramic composites. In particular, FIGS. 10E and 10F depict a die assembly 1060, which can include one or more concentration spacers 1068. In some embodiments, the one or more concentration spacers 1068 may include a frustoconical or partially frustoconical geometry configured to facilitate the conductivity of electricity to the components disposed therebetween. In some embodiments, the die assembly can further include a top core structure 1062, a bottom core structure 1064, and a center core post structure 1066. The center core post structure 1066 can be disposed in the center of sample 1061. In some embodiments, a die assembly 1060 may include an outer core structure 1067 that may be configured to surround the top core structure 1062, a bottom core structure 1064, a center core post structure 1066, and/or sample, as illustrated in FIG. 10F.

In some embodiments, a preform or a green body can be loaded into the die of a field assisted sintering machine for sintering. In some embodiments, one or more sheets of tape can be loaded into a die of a field assisted sintering machine for sintering. In some embodiments, one or more materials can be loaded into a die of a sintering machine for sintering without first preforming the one or more materials. For example and without limitation, when manufacturing graphite, coked mesophase pitch can be loaded into a die of a field assisted sintering machine for sintering without first preforming the coked mesophase pitch.

### FAST/SPS Parameters

Sintering may involve loading the one or more materials into a field assisted sintering technology (FAST) machine (e.g., any of those shown in and described with respect to FIGS. 10A-10F), which can also be referred to as a spark plasma sintering (SPS) machine. The FAST/SPS machine can be used to simultaneously or sequentially conduct electricity through and apply pressure to one or more materials within a die of the machine.

In some embodiments, the method of manufacturing a carbon-based material may include providing, selecting, identifying, calculating, or using one or more sintering parameters. The one or more parameters may be controllable settings that influence a sintering process on a field assisted sintering machine. The parameters may be selected to influence the mechanical, thermal, electrical and/or other material properties of the final product.

The parameters may include the target temperature that the formulation, preform, or green body component will reach during the sintering process. Manufacturing a C—C or a C—C—SiC composite may involve sintering the one or more materials at a target temperature of 2,000 °C or approximately 2,000 °C, or in a range from 1,900 °C or approximately 1,900 °C to 2,100 °C or approximately 2,100 °C, or from 1,800 °C or approximately 1,800 °C to 2,200 °C or approximately 2,200 °C, or any value, approximate value, or range of values within the foregoing ranges. Manufacturing a graphite component may include sintering at a target temperature of 2,000 °C or approximately 2,000 °C, or in a range from 1,800 °C or approximately 1,800 °C to 2,200 °C or approximately 2,200 °C, or in a range from 1,600 °C or approximately 1,600 °C to 2,400 °C or approximately 2,400 °C, or from 1,400 °C or approximately 1,400 °C to 2,600 °C or approximately 2,600 °C, or from 1,200 °C or approximately 1,200 °C to 2,800 °C or approximately 2,800 °C, or from 1,000 °C or approximately 1,000 °C to 3,000 °C or approximately 3,000 °C, or at a temperature greater than 3,000 °C, or of any value, approximate value, or range of values within any of the foregoing ranges.

A parameter may include a ramp rate, which may be a rate at which the formulation, preform, or green body component reaches the target temperature. Manufacturing a carbon-based material may include sintering at a ramp rate of 50 °C/minute or approximately 50 °C/minute, or in a range from 40 °C/minute or approximately 40 °C/minute to 60 °C/minute or approximately 60 °C/minute, or from 30 °C/minute or approximately 30 °C/minute to 70 °C/minute or approximately 70 °C/minute, or from 20 °C/minute or approximately 20 °C/minute to 80 °C/minute or approximately 80 °C/minute, or from 10 °C/minute or approximately 10 °C/minute to 90 °C/minute or approximately 90 °C/minute, or from 0 °C/minute or approximately 0 °C/minute to 100 °C/minute or approximately 100 °C/minute, or any value, approximate value, or range of values within any range of the foregoing ranges. Larger parts can be sintered at a ramp rate of 35 °C/minute or approximately 35 °C/minute, or in a range from 30 °C/minute or approximately 30 °C/minute to 40 °C/minute or approximately 40 °C/minute, or from 25 °C/minute or approximately 25 °C/minute to 45 °C/minute or approximately 45 °C/minute, or from 20 °C/minute or approximately 20 °C/minute to 50 °C/minute or approximately 50 °C/minute, or any value, approximate value, or range of values within any range of the foregoing ranges. Smaller parts can be sintered at higher ramp rates. For example and without limitation, smaller parts can be sintered at a ramp rate of 100 °C/minute or approximately 100 °C/minute, or in a range from 50 °C/minute or approximately 50 °C/minute to 150 °C/minute or approximately 150 °C/minute, or from 0 °C/minute or approximately 0 °C/minute to 200 °C/minute or approximately 200 °C/minute, or from 0 °C/minute or approximately 0 °C/minute to 250 °C/minute or approximately 250 °C/minute, or any value, approximate value, or range of values within any range of the foregoing ranges. In some embodiments, it may be advantageous to use a smaller ramp rate for larger parts because larger parts may develop a thermal gradient if they are heated too quickly, which may interfere with temperature readings and/or sintering quality.

In some embodiments, a parameter may include a time at temperature, which may be a length of time that the formulation, preform, or green body component is held at the target temperature. For example and without limitation, a formulation, preform, or green body component may be held at a target temperature for 45 minutes or approximately 45 minutes, or in a range from 40 minutes or approximately 40 minutes to 50 minutes or approximately 50 minutes, or from 35 minutes or approximately 35 minutes to 55 minutes or approximately 55 minutes, or from 30 minutes or approximately 30 minutes to 60 minutes or approximately 60 minutes, or of any value, approximate value, or range of values within any of the foregoing ranges. For example and without limitation, a part with a 2 inch diameter or approximately a 2 inch diameter may be held at a target temperature for 20 minutes or approximately 20 minutes, or in a range from 10 minutes or approximately 10 minutes to 30 minutes or approximately 30 minutes, or any value, approximate value, or range of values within any of the foregoing ranges. For example and without limitation, a part with a diameter in a range from 4 inches or approximately 4 inches to 10 inches or approximately 10 inches, or any value, approximate value, or range of values within the foregoing range, may be held at a target temperature for 30 minutes or approximately 30 minutes, or in a range from 20 minutes or approximately 20 minutes to 45 minutes or approximately 45 minutes, or any value, approximate value, or range of values within any of the foregoing ranges. For example and without limitation, a part with a diameter greater than 10 inches may be held at a target temperature for 60 minutes or approximately 60 minutes, or in a range from 30 minutes or approximately 30 minutes to 120 minutes or approximately 120 minutes, or any value, approximate value, or range of values within any of the foregoing ranges.

In some embodiments, a parameter may be a pressure applied to the die by the field assisted sintering machine. In some embodiments, manufacturing a C—C or C—C—SiC composite comprising pitch fiber may include applying pressure of 40 MPa or approximately 40 MPa during sintering, or in a range from 35 MPa or approximately 35 MPa to 45 MPa or approximately 45 MPa, or from 30 MPa or approximately 30 MPa to 50 MPa or approximately 50 MPa. In some embodiments, manufacturing a C—C or C—C—SiC composite comprising PAN fiber may include applying pressure of 60 MPa or approximately 60 MPa, or in a range from 55 MPa or approximately 55 MPa to 65 MPa or approximately 65 MPa, or from 50 MPa or approximately 50 MPa to 70 MPa or approximately 70 MPa. In some embodiments, manufacturing graphite may include applying pressure of 65 MPa or approximately 65 MPa, or in a range from 60 MPa or approximately 60 MPa to 70 MPa or approximately 70 MPa, or from 55 MPa or approximately 55 MPa to 75 MPa or approximately 75 MPa, or of any value, approximate value, or range of values within any of the foregoing ranges.

In some embodiments, the pressure applied to the one or more materials or the preform can be changed as the temperature of the one or more materials or the preform changes. For example and without limitation, the pressure can be controlled to be between 15 MPa or approximately 15 MPa and 30 MPa or approximately 30 MPa until a temperature of the one or more materials or the preform reaches a threshold temperature, which can be 1,500 °C or approximately 1,500 °C, or in a range from 1,300 °C or approximately 1,300 °C to 1,700 °C or approximately 1,700 °C, or in a range from 1,100 °C or approximately 1,100 °C to 1,900 °C or approximately 1,900 °C, or any value, approximate value, or range of values within the foregoing ranges. After the one or more materials or the preform reach the threshold temperature, the pressure applied to the one or more materials can be increased to be in a range from 35 MPa or approximately 35 MPa to 70 MPa or approximately 70 MPa, or any value, approximate value, or range of values within the foregoing range.

When manufacturing a component with pitch-based fibers, it may be advantageous to apply a pressure between 35 MPa or approximately 35 MPa and 50 MPa or approximately 50 MPa, or any value, approximate value, or range of values within the foregoing range. When manufacturing a component with PAN-based fibers, it may be advantageous to apply a pressure between 45 MPa or approximately 45 MPa and 70 MPa or approximately 70 MPa, or any value, approximate value, or any range of values within the foregoing range. For example and without limitation, when manufacturing a component with PAN-based fibers, a pressure of 65 MPa or approximately 65 MPa can be applied during sintering.

A small component may be a component having a diameter of 0.5 inch or approximately 0.5 inch to 12 inches or approximately 12 inches, or any value, approximate value, or range of values within the foregoing range. A large component may be a component having a diameter larger than 12 inches or approximately 12 inches. When referring to component size, diameter may refer to the diameter of a circle or sphere in which the component can fit, for example, if the component itself is not circular. For example and without limitation, a nozzle that can fit within or be confined by a sphere having a diameter of 12 inches or approximately 12 inches may be referred to as a small component. When manufacturing a large component, it may be advantageous to apply a pressure between 35 MPa or approximately 35 MPa and 50 MPa or approximately 50 MPa, or any value, approximate value, or range of values within the foregoing range. When manufacturing a small component, it may be advantageous to apply a pressure between 45 MPa or approximately 45 MPa and 70 MPa or approximately 70 MPa, or any value, approximate value, or any range of values within the foregoing range. When manufacturing a small component it may be advantageous to use a ramp rate of 150 °C/minute or approximately 150 °C/minute, or in a range from 120 °C/minute or approximately 120 °C/minute to 180 °C/minute or approximately 180 °C/minute, or any value, approximate value, or range of values within the foregoing range. When manufacturing a large component, it may be advantageous to use a ramp rate in a range from 20 °C/minute or approximately 20 °C/minute to 50 °C/minute or approximately 50 °C/minute, or any value, approximate value, or range of values within the foregoing range.

When manufacturing a graphite component, it may be advantageous to sinter with a higher pressure because a higher pressure may cause the pitch to graphitize faster. In some embodiments, manufacturing graphite may include applying pressure of 85 MPa or approximately 85 MPa during sintering, or in a range from 70 MPa or approximately 70 MPa to 100 MPa or approximately 100 MPa, or from 65 MPa or approximately 65 MPa to 115 MPa or approximately 115 MPa, or from 50 MPa or approximately 50 MPa to 130 MPa or approximately 130 MPa, or from 35 MPa or approximately 35 MPa to 145 MPa or approximately 145 MPa or any value, approximate value, or range of values within the foregoing ranges. In some embodiments, manufacturing graphite may include applying pressure of 150 MPa during sintering, or in a range from 125 MPa or approximately 125 MPa to 175 MPa or approximately 175 MPa, or from 100 MPa or approximately 100 MPa to 200 MPa or approximately 200 MPa, or any value, approximate value, or range of values in the foregoing ranges. In some embodiments, a die comprising a carbon-carbon composite may be configured to apply pressures between 150 MPa or approximately 150 MPa to 200 MPa or approximately 200 MPa during sintering.

In some embodiments, a parameter may include a cooling rate, which may be a rate at which the formulation, preform, or green body component is allowed to cool. For example and without limitation, a cooling rate may be the same or similar to the ramp rate.

In some embodiments, a parameter may include an environment within the field assisted sintering machine. For example and without limitation, the environment within the field assisted sintering may include an inert gas, such as but not limited to argon or nitrogen. In some embodiments, the environment can be oxygenated, and in some embodiments, the environment may be controlled to not contain oxygen.

In some embodiments, a parameter may include chamber dimensions, such as but not limited to the shape, height, width, length, and/or diameter of the chamber.

In some embodiments, a parameter may include the current that is passed through the die. In some embodiments, the controller may be configured to determine how much current to pass through the one or more materials based on a target temperature, the resistance of the one or more materials, a measured temperature of the one or more materials, and/or another variable. For example and without limitation, the controller may use a feedback loop to increase or decrease an amount of current based on a measured temperature and a target temperature of the one or more materials.

In some embodiments, a parameter may include one or more properties of the die, such as a resistance of the die, a coefficient of thermal expansion of the die, and/or other mechanical, thermal, or electrical properties of the die. In some embodiments, sintering may include selecting a die having particular mechanical, thermal, or electrical properties based at least in part on the one or more materials in the formulation. For example and without limitation, a formulation may include materials that are relatively conductive, which may inhibit inductive heating of the formulation during a sintering process. In such an embodiment, it may be advantageous to select or use a die that is relatively more resistive in order to supplement the heating of the formulation. In some embodiments, if the one or more materials in a formulation are relatively more resistive, it may be advantageous to select or use a die that is relatively more conductive to heat the formulation. For example and without limitation, if a formulation includes PAN fibers, the formulation may be relatively more resistive, and it may be advantageous to select and use a die that is relatively more conductive, and if a formulation includes pitch fibers, the formulation may be relatively more conductive, and it may be advantageous to select or use a die that is relatively more resistive. In some embodiments, a parameter may be the die material, or the one or more materials that comprise the die. It may be advantageous for a die to have a coefficient of thermal expansion (CTE) that is similar to that of the formulation, preform, or green body component to prevent damage to the die or the field assisted sintering machine. Accordingly, a method of manufacturing a carbon-carbon composite may include selecting a die material having a similar coefficient of thermal expansion to the formulation or one or more materials in the formulation. If a die includes one or more materials having a CTE that is higher than the CTE of the one or more materials in the formulation, this can cause the die to expand and break during a sintering process.

A method of manufacturing a carbon-carbon composite may include providing, selecting, identifying, calculating, or using one or more parameters to produce a carbon-based component having one or more desired or target material properties, such as but not limited to mechanical, thermal, electrical, and/or other material properties of the one or more materials in the formulation. For example, in some embodiments, a method may include setting one or more parameters based at least in part on whether the formulation includes pitch fiber, such as but not limited to mesophase pitch carbon fiber. For example and without limitation, if a formulation includes pitch fiber, a method may include selecting a first pressure, a first target temperature, a first ramp rate, and/or a first time at temperature. For example and without limitation, if a formulation includes PAN fiber, a method may include selecting a second pressure, a second target temperature, a second ramp rate, and/or a second time at temperature.

### Post Machining

In some embodiments, a method of manufacturing a carbon-based component may include post-machining a part. Post-machining may include removing a sintered component from a die after a sintering process. Post-machining may include removing a sintered component from a field assisted sintering machine after electrical current and/or pressure have been applied by the field assisted sintering machine.

Post-machining may include one or more of grinding, polishing, milling, turning, cutting, or other machining processes. Post-machining may include using a diamond coated ceramic (tile) blade. In some embodiments, post-machining may include grinding or flattening a surface of component. For example and without limitation, post-machining may include grinding or flattening an end of a sintered cylindrical component. In some embodiments, post-machining may include using a tile saw or a similar chop saw, for example and without limitation, to produce a straight cut.

Post-machining can be used to produce complex shapes, components, or features. For example and without limitation, post-machining may include producing complex shapes, components, or features using a computer numerical control (CNC) mill, which may include a diamond sand coated routing bit, or a similarly coated routing bit.

Post-machining may include applying one or more processing steps to a sintered part or component to achieve a desired dimension, finish, property, and/or feature. In some embodiments, post-machining may include determining, selecting, or applying one or more processing steps based at least in part on the one or more materials in the formulation. For example and without limitation, post-machining may include determining, selecting, or applying one or more processing steps based at least in part on a type and length of fiber in a formulation, such as but not limited to whether a formulation includes chopped carbon fiber, two-dimensional laminate carbon fiber, pitch fiber, PAN fiber, or another type of fiber.

In some embodiments, for carbon-based components including discontinuous pitch fibers between about 0.125 inches and 2 inches in length, a specified amount of material can be machined off the top, bottom, and side surfaces. In some embodiments, an amount of material to be machined off can be 3 mm or about 3 mm, or in a range from 2.5 mm or approximately 2.5 mm to 3.5 mm or approximately 3.5 mm, or from 2 mm or approximately 2 mm to 4 mm or approximately 4 mm, or from 1.5 mm or approximately 1.5 mm to 4.5 mm or approximately 4.5 mm, or from 1 mm or approximately 1 mm to 5 mm or approximately 5 mm, or of any value, approximate value, or range of values within any of the foregoing ranges.

In some embodiments, for carbon-based components including discontinuous PAN fibers between about 0.125 inches and 2 inches in length, a specified amount of material can be machined off the top, bottom, and side surfaces. In some embodiments, an amount of material to be machined off can be 5 mm or approximately 5 mm, or in a range from 4.5 mm or approximately 4.5 mm to 5.5 mm or approximately 5.5 mm, or from 4 mm or approximately 4 mm to 6 mm or approximately 6 mm, or from 3.5 mm or approximately 3.5 mm to 6.5 mm or approximately 6.5 mm, or from 3 mm or approximately 3 mm to 7 mm or approximately 7 mm, or of any value, approximate value, or range of values within any of the foregoing ranges.

### EXAMPLES

### Carbon-Carbon Composite

Manufacturing a carbon-carbon component may include providing a formulation comprising pitch (mesophase or isotropic), carbon fiber (discontinuous or continuous, pitch-based or PAN-based), milled carbon fibers, and/or coked mesophase pitch, and may be in the proportions in the table below, or in any value, approximate value, or range of values within the provided ranges. In some embodiments, the formulation can include only discontinuous fibers, only continuous fibers, or a hybrid of some continuous fibers and some discontinuous fibers. In some embodiments, the formulation may include only continuous fibers and milled fibers, and may not include any fibers having lengths of 1 inch or approximately 1 inch, or in a range from ⅛ inch or approximately ⅛ inch to 2 inches or approximately 2 inches.

The pitch, milled carbon fibers, and/or coked mesophase pitch can be milled into a powder and mixed. If using discontinuous fibers, the discontinuous fibers can then be mixed with the powdered materials. If using continuous fibers, the powdered materials can be layered between one or more continuous sheets of carbon fiber. The combined materials (e.g., the pitch, milled carbon fibers, coked pitch (e.g., partially and/or fully coked pitch), and/or carbon fibers) can then be preformed at a temperature between 350 °C or approximately 350 °C and 420 °C or approximately 420 °C, and at a pressure between 3 MPa or approximately 3 MPa and 70 MPa or approximately 70 MPa. In some embodiments, the pressure can be between 1 MPa or approximately 1 MPa and 20 MPa or approximately 20 MPa, or any value, approximate value, or range of values within the foregoing ranges. The combined materials can be preformed until a tap density between 1.2×-1.4× of the final dimensions is achieved for small parts, or between 1.7×-1.9× of the final dimensions is achieved for large parts. The preform can then be loaded into a die of a field assisted sintering machine for sintering. The preform can be sintered at a target temperature of between 1,800 °C or approximately 1,800 °C and 2,200 °C or approximately 2,200 °C. During sintering, pressure can be applied between 15 MPa or approximately 15 MPa and 30 MPa or approximately 30 MPa until the preform reaches a threshold temperature, which can be 1,500 °C or approximately 1,500 °C. In some embodiments, the pressure applied during sintering can be between approximately 20 MPa and approximately 70 MPa, or any value, approximate value, or range of values within the foregoing ranges. After a threshold temperature is reached, pressure can be increased. If pitch-based fibers are being used, pressure may be increased to between 35 MPa or approximately 35 MPa and 50 MPa or approximately 50 MPa. If using PAN-based fibers, pressure may be increased to between 45 MPa or approximately 45 MPa and 70 MPa or approximately 70 MPa. During sintering, if making a small component, temperature can be increased at a ramp rate of up to 150 °C/minute. If making a large component, temperature can be increased at a ramp rate of between 20 °C/minute and 50 °C/minute. The preform can be held at the target temperature for a period of time between 30 minutes or approximately 30 minutes and 60 minutes or approximately 60 minutes. After sintering, the part can be post-machined to reach final dimensions. In some embodiments, as an alternative to preforming, the one or more mixed materials can be compacted into sheets using high shear compaction. The sheets can be layered with continuous carbon fibers and then loaded into a field assisted sintering machine and sintered using the parameters above or below. The carbon-carbon component can be produced in a single preforming step and a single sintering step. The preforming step and the sintering step can each include a single thermal cycle. The carbon-carbon component can be produced without repeated infiltration steps. The carbon-carbon component can be produced without using resins. The carbon-carbon component can be produced without using phenolic resins. The carbon-carbon component can be produced without using polymer-infiltration and pyrolysis (PIP). The carbon-carbon component can be produced without using chemical vapor infiltration (CVI).

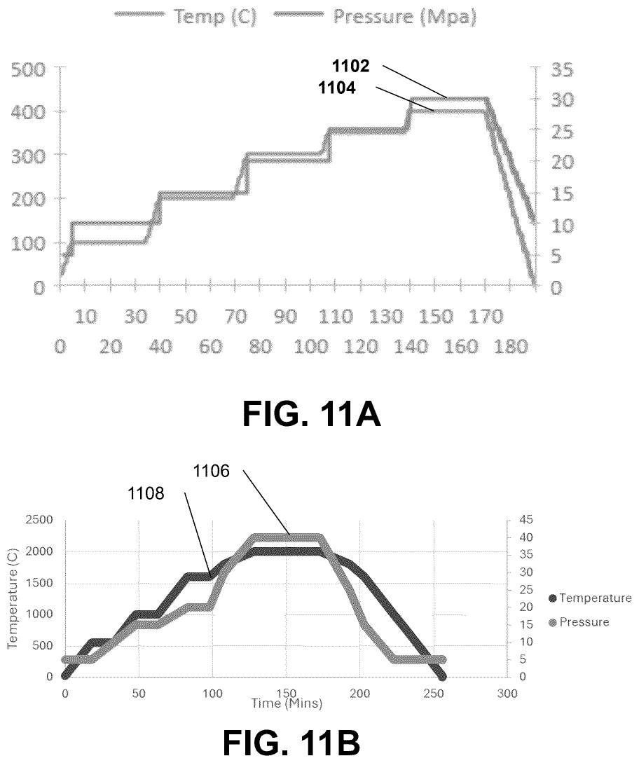

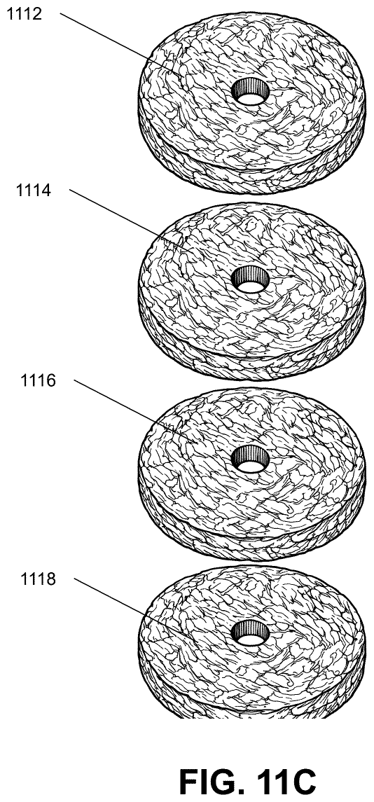

FIG. 11A illustrates a table with example preforming parameters. The left-side y-axis represents the temperature (in °C) of the preforming machine and/or the materials therein. The right-side y-axis represents the pressure (in MPa) applied by the preforming machine to the materials therein. The x-axis represents the time (in minutes). Preforming can be performed using a hot press. Line 1102 represents pressure, and line 1104 represents temperature. The materials can be heated, via the hot press, to a target preforming temperature of 425 °C or approximately 425 °C, or from 400 °C or approximately 400 °C to 450 °C or approximately 450 °C, or from 350 °C or approximately 350 °C to 500 °C or approximately 500 °C, or any value, approximate value, or range of values within the foregoing ranges. The combined materials can be pressed, via the hot press, to a target preforming pressure of 30 MPa or approximately 30 MPa, or from 25 MPa or approximately 25 MPa to 35 MPa or approximately 35 MPa, or from 3 MPa or approximately 3 MPa to 70 MPa or approximately 70 MPa, or any value, approximate value, or range of values within the foregoing ranges. The target preforming temperature and/or the target preforming pressure can be reached within 140 minutes or approximately 140 minutes, or from 120 minutes or approximately 120 minutes to 160 minutes or approximately 160 minutes, or from 60 minutes or approximately 60 minutes to 240 minutes or approximately 240 minutes, or any value, approximate value, or range of values within the foregoing ranges. The hot press can be held at the target preforming temperature and/or the target preforming pressure for 30 minutes or approximately 30 minutes, or from 20 minutes or approximately 20 minutes to 40 minutes or approximately 40 minutes, or from 10 minutes or approximately 10 minutes to 60 minutes or approximately 60 minutes, or any value, approximate value, or range of values within the foregoing ranges. As shown in FIG. 11A, the preforming temperature and the preforming pressure can be increased at similar rates. The temperature and/or the pressure can be incrementally increased and held constant for hold periods, which can be used to control the rate of out-gassing. The preforming temperature and the preforming pressure can reach the target preforming temperature and pressure at the same or similar times. After reaching and/or being held at the target preforming temperature and/or pressure, the preforming temperature and/or pressure can be decreased to remove the materials (e.g., the preform) from the hot press.

The preforming parameters illustrated in FIG. 11A are examples. The preforming parameters illustrated in FIG. 11A can be used for larger components (e.g., those having approximately 325 mm in width). Smaller components may use different preforming parameters (e.g., reduced target preforming pressure, etc.). The preforming parameters can be changed from those illustrated based on the materials, size, shape, and/or desired material properties of the final component.

FIG. 11B illustrates a table with example field assisted sintering parameters. The left-side y-axis represents the temperature (in °C) of the field assisted sintering machine and/or the materials (e.g., the preform, the materials combined with tape, etc.) therein. The right-side y-axis represents the pressure (in MPa) applied by the field assisted sintering machine to the materials therein. The x-axis represents the time (in minutes). Line 1106 represents pressure, and line 1108 represents temperature. The materials can be heated, via the field assisted sintering machine, to a target temperature of 2,000 °C or approximately 2,000 °C, or from 1,900 °C or approximately 1,900 °C to 2,100 °C or approximately 2,100 °C, or from 1,800 °C or approximately 1,800 °C to 2,200 °C or approximately 2,200 °C, or any value, approximate value, or range of values within the foregoing ranges. The materials can be pressed, via the field assisted sintering machine, to a target pressure of 40 MPa or approximately 40 MPa, or from 35 MPa or approximately 35 MPa to 45 MPa or approximately 45 MPa, or from 15 MPa or approximately 15 MPa to 70 MPa or approximately 70 MPa, or any value, approximate value, or range of values within the foregoing ranges. The target temperature and/or the target pressure can be reached within 120 minutes or approximately 120 minutes, or from 110 minutes or approximately 110 minutes to 130 minutes or approximately 130 minutes, or from 60 minutes or approximately 60 minutes to 240 minutes or approximately 240 minutes, or any value, approximate value, or range of values within the foregoing ranges. The field assisted sintering machine can be held at the target temperature and/or the target pressure for 30 minutes or approximately 30 minutes, or from 20 minutes or approximately 20 minutes to 40 minutes or approximately 40 minutes, or from 10 minutes or approximately 10 minutes to 60 minutes or approximately 60 minutes, or any value, approximate value, or range of values within the foregoing ranges. As shown in FIG. 11B, the temperature and the pressure can be increased at similar rates. The temperature and/or the pressure can be incrementally increased and held constant for hold periods, which can be used to control the rate of out-gassing. The temperature and the pressure can reach the target temperature and pressure at the same or similar times. After reaching and/or being held at the target temperature and/or pressure, the temperature and/or pressure can be decreased to remove the sintered component from the field assisted sintering machine.

The field assisted sintering parameters illustrated in FIG. 11B are examples. The field assisted sintering parameters illustrated in FIG. 11B can be used for larger components (e.g., approximately 325 mm in width). Smaller components may use different preforming parameters (e.g., faster increase in temperature and/or pressure, fewer hold periods while increasing the temperature and/or pressure, etc.). The field assisted sintering parameters can be changed from those illustrated based on the materials, size, shape, and/or desired material properties of the final component.

FIG. 11C illustrates example carbon-carbon components manufactured using the preforming and sintering parameters of FIGS. 11A and 11B. Each of the components shown in FIG. 11C was produced using discontinuous PAN fibers, mesophase pitch, and milled fibers. Each of the components shown in FIG. 11C was produced in a single thermal and/or densification cycle (e.g., one preforming cycle, and one sintering cycle, as illustrated in FIGS. 11A and 11B). FIG. 11C illustrates a first component 1112, a second component 1114, a third component 1116, and a fourth component 1118, which are in no particular order. Each of the components has a diameter of approximately 2 inches. The first component 1112 has a density of 1.86+/−0.02 g/cm³. The second component 1114 has a density of 1.85+/−0.02 g/cm³. The third component 1116 has a density of 1.86+/−0.02 g/cm³. The fourth component 1118 has a density of 1.83+/−0.02 g/cm³.

The following table identifies ten example components that were manufactured using the methods described herein, where each row identifies a different component, the materials used to make the component, and density measurements. The “Fiber” column identifies the type of fiber in the component and the percentage of the fiber in the formulation as a percentage of volume, where “chopped” refers to discontinuous fibers having lengths between approximately 0.125 inches and approximately 2 inches, “2D woven” refers to two-dimensional woven carbon fibers, and “UD” refers to unidirectional carbon fibers. The “Pitch” column refers to the amount of mesophase pitch in the formulation as a percentage of volume. The entry identified as “(coked)” refers to mesophase pitch that has been coked at 600 °C or approximately 600 °C. The “Milled Fiber” column refers to the amount of milled carbon fibers (e.g., pitch-based carbon fibers) used in the formulation as a percentage of volume. The “Max Pressure” column refers to the maximum pressure applied during sintering. The maximum temperature of each of the components was approximately 2,000 °C. The “Theoretical Density” column refers to the theoretical density of the component, as calculated using the equation provided above. The “Porosity” column refers to the estimated porosity of the component as a percentage of volume. The table identifies the densities of example components as determined by the dimensions of the components and by Archimedes testing. The pp column refers to dimensional density, and the ρ_{A} column refers to density as measured using Archimedes testing. Dimensional density is calculated from the mass and measured dimensions of the part (e.g., ρ_{D}=mass/volume). Archimedes density is measured using buoyancy in a fluid (e.g., ρ_{A}=[mass in air/(mass in air−mass in fluid)]*density of fluid). The first four components of the table are those of FIG. 11C. Each of the components in the table below has a 2-inch diameter. The “ρ_{D} %” column refers to the ratio of the dimensional density to the theoretical density. The “ρ_{A} %” column refers to the ratio of the Archimedes density to the theoretical density. Each of the components in the table below was produced in one preforming cycle and one sintering cycle, which each included parameters that are the same as or similar to those illustrated in FIGS. 11A and 11B. The example formulations, parameters, and measurements provided in the table below are non-limiting examples. As described throughout this disclosure, other materials, percentages (e.g., or ranges of percentages) of materials, manufacturing parameters, densities, etc. are contemplated.

| | | | Max | Theoretical | | | | | |
|---|---|---|---|---|---|---|---|---|---|
| | | Milled | Pressure | density | | | | | |
| Fiber | Pitch | Fiber | (MPa) | (g/cc) | Porosity | ρ_{D} | ρ_{D} % | ρ_{A} | ρ_{A} % |
| Chopped; PAN; 45% | 20% | 35% | 45 | 2.00 | ~2.0% | 1.860 | 93% | 1.860 | 93% |
| Chopped; PAN; 45% | 20% | 35% | 45 | 2.00 | ~2.0% | 1.832 | 92% | 1.850 | 93% |
| Chopped; PAN; 45% | 20% | 35% | 45 | 2.00 | ~2.0% | 1.790 | 90% | 1.860 | 93% |
| Chopped; PAN; 45% | 20% | 35% | 45 | 2.00 | ~2.0% | 1.777 | 89% | 1.830 | 92% |
| 2D woven; 55% | 45% | 0% | 65 | 1.98 | ~5.0% | 1.774 | 90% | 1.907 | 96% |
| 2D-woven; 55% | 20% | 25% | 65 | 1.98 | ~5.0% | 1.817 | 92% | 1.921 | 97% |
| UD; 45% | 55% (coked) | 0% | 65 | 1.98 | ~1.5% | 1.836 | 93% | 1.965 | 99% |
| UD; 45% | 20% | 35% | 65 | 1.99 | ~5.0% | 1.717 | 86% | 1.895 | 95% |
| Chopped; PAN; 45% | 25% | 30% | 65 | 2.02 | ~5.0% | 1.816 | 90% | 1.880 | 93% |
| Chopped; PAN; 45% | 20% | 35% | 65 | 2.02 | ~5.0% | 1.833 | 91% | 1.921 | 95% |

The following tables illustrate example formulations, carbon fibers, sintering preparations (preforming vs. high shear compaction), desired sizes of final components, and sintering parameters. These examples are not limiting.

Formulation
40-55% Fiber (Pitch or Pan)
10-35% Binder (Mesophase or Isotropic Pitch)
0-40% Milled Fiber
0-40% Coked Mesophase Pitch

| | Type of | Sintering | Size of Final | FAST Target | FAST Ramp | |
|---|---|---|---|---|---|---|
| Fiber | Fiber | Prep | Component | Temp | Rate | FAST Pressure |
| Continuous | Pitch | Preforming | Small | 1,800 C-2,200 C | Up to 150 C/min | 35 MPa-50 MPa |
| Continuous | Pitch | Preforming | Large | 1,800 C-2,200 C | 20-50 C/min | 35 MPa-50 MPa |
| Continuous | Pitch | High Shear | Small | 1,800 C-2,200 C | Up to 150 C/min | 35 MPa-50 MPa |
| | | Compaction | | | | |
| Continuous | Pitch | High Shear | Large | 1,800 C-2,200 C | 20-50 C/min | 35 MPa-50 MPa |
| | | Compaction | | | | |
| Continuous | PAN | Preforming | Small | 1,800 C-2,200 C | Up to 150 C/min | 45 MPa-70 MPa |
| Continuous | PAN | Preforming | Large | 1,800 C-2,200 C | 20-50 C/min | 45 MPa-70 MPa |
| Continuous | PAN | High Shear | Small | 1,800 C-2,200 C | Up to 150 C/min | 45 MPa-70 MPa |
| | | Compaction | | | | |
| Continuous | PAN | High Shear | Large | 1,800 C-2,200 C | 20-50 C/min | 45 MPa-70 MPa |
| | | Compaction | | | | |
| Discontinuous | Pitch | Preforming | Small | 1,800 C-2,200 C | Up to 150 C/min | 35 MPa-50 MPa |
| Discontinuous | Pitch | Preforming | Large | 1,800 C-2,200 C | 20-50 C/min | 35 MPa-50 MPa |
| Discontinuous | PAN | Preforming | Small | 1,800 C-2,200 C | Up to 150 C/min | 45 MPa-70 MPa |
| Discontinuous | PAN | Preforming | Large | 1,800 C-2,200 C | 20-50 C/min | 45 MPa-70 MPa |

### Carbon-Based Composite

Manufacturing a carbon-based composite may include providing a formulation comprising pitch (mesophase or isotropic), carbon fiber (discontinuous or continuous, pitch-based or PAN-based), milled carbon fibers, coked mesophase pitch, TiC, B₄C, SiC, ZrC, TaC, WC, MoB2, TiB2, ZrB₂, TaB2, HfC, and/or HfB₂, and may be in the proportions in the table below, or in any value, approximate value, or range of values within the provided ranges. The formulation can include only discontinuous fibers, only continuous fibers, or a hybrid of some continuous fibers and some discontinuous fibers. In some embodiments, the formulation may include only continuous fibers and milled fibers, and may not include any fibers having lengths of 1 inch or approximately 1 inch, or in a range from ⅛ inch or approximately ⅛ inch to 2 inches or approximately 2 inches.

The pitch, milled carbon fibers, coked mesophase pitch, and/or additional materials can be milled into a powder and mixed. If using discontinuous fibers, the discontinuous fibers can then be mixed with the powdered materials. If using continuous fibers, the powdered materials can be layered between one or more continuous sheets of carbon fiber. The combined materials and carbon fiber can then be preformed at a temperature between 350 °C or approximately 350 °C and 420 °C or approximately 420 °C and at a pressure between 3 MPa or approximately 3 MPa and 70 MPa or approximately 70 MPa. The combined materials can be preformed until a tap density between 1.2×-1.4× of final dimensions is achieved for small parts, or between 1.7×-1.9× of final dimensions is achieved for large parts. The preform can then be loaded into a die of a field assisted sintering machine for sintering. The preform can be sintered at a target temperature of between 1,800 °C or approximately 1,800 °C and 2,200 °C or approximately 2,200 °C. During sintering, pressure can be applied between 15 MPa or approximately 15 MPa and 30 MPa or approximately 30 MPa until the preform reaches a threshold temperature, which can be 1,500 °C or approximately 1,500 °C. After a threshold temperature is reached, pressure can be increased. If pitch-based fibers are being used, pressure may be increased to between 35 MPa or approximately 35 MPa and 50 MPa or approximately 50 MPa. If using PAN-based fibers, pressure may be increased to between 45 MPa or approximately 45 MPa and 70 MPa or approximately 70 MPa. During sintering, if making a small component, temperature can be increased at a ramp rate of up to 150 °C/minute. If making a larger component, temperature can be increased at a ramp rate of between 20 °C/minute and 50 °C/minute. The preform can be held at the target temperature for a period of time between 30 minutes or approximately 30 minutes and 60 minutes or approximately 60 minutes. After sintering, the part can post-machined to reach final dimensions. In some embodiments, as an alternative to preforming, the one or more mixed materials can be compacted into sheets using high shear compaction. The sheets can be layered with continuous carbon fibers and then loaded into a field assisted sintering machine and sintered using the parameters above. The carbon-based component can be produced in a single preforming step and a single sintering step. The preforming step and the sintering step can each include a single thermal cycle. The carbon-based component can be produced without repeated infiltration steps. The carbon-based component can be produced without using resins. The carbon-based component can be produced without using phenolic resins. The carbon-based component can be produced without using polymer-infiltration and pyrolysis (PIP). The carbon-based component can be produced without using chemical vapor infiltration (CVI).

The following tables illustrate example formulations, carbon fibers, sintering preparations (preforming vs. high shear compaction), desired sizes of final components, and sintering parameters. These examples are not limiting. For example and without limitation, a formulation can include 20% or approximately 20% mesophase pitch, 35% or approximately 35% milled carbon fiber, and 45% or approximately 45% chopped carbon fiber.

| | | Formulation | | | | |
|---|---|---|---|---|---|---|
| | | 40-55% Fiber (Pitch or PAN) | | | | |
| | | 10-35% Binder (Mesophase or Isotropic Pitch) | | | | |
| | | 0-45% Milled Carbon Fiber | | | | |
| | | 0-40% Coked Mesophase Pitch | | | | |
| | | 5-50% TiC, B4C, SiC, ZrC, TaC, WC, MoB2, TiB2, ZrB2, | | | | |
| | | TaB2, HfC, and/or HfB2 | | | | |
| | Type of | Sintering | Size of Final | FAST Target | FAST Ramp | |
| Fiber | Fiber | Prep | Component | Temp | Rate | FAST Pressure |
| Continuous | Pitch | Preforming | Small | 1,800 C-2,200 C | Up to 150 C/min | 35 MPa-50 MPa |
| Continuous | Pitch | Preforming | Large | 1,800 C-2,200 C | 20-50 C/min | 35 MPa-50 MPa |
| Continuous | Pitch | High Shear | Small | 1,800 C-2,200 C | Up to 150 C/min | 35 MPa-50 MPa |
| | | Compaction | | | | |
| Continuous | Pitch | High Shear | Large | 1,800 C-2,200 C | 20-50 C/min | 35 MPa-50 MPa |
| | | Compaction | | | | |
| Continuous | PAN | Preforming | Small | 1,800 C-2,200 C | Up to 150 C/min | 45 MPa-70 MPa |
| Continuous | PAN | Preforming | Large | 1,800 C-2,200 C | 20-50 C/min | 45 MPa-70 MPa |
| Continuous | PAN | High Shear | Small | 1,800 C-2,200 C | Up to 150 C/min | 45 MPa-70 MPa |
| | | Compaction | | | | |
| Continuous | PAN | High Shear | Large | 1,800 C-2,200 C | 20-50 C/min | 45 MPa-70 MPa |
| | | Compaction | | | | |
| Discontinuous | Pitch | Preforming | Small | 1,800 C-2,200 C | Up to 150 C/min | 35 MPa-50 MPa |
| Discontinuous | Pitch | Preforming | Large | 1,800 C-2,200 C | 20-50 C/min | 35 MPa-50 MPa |
| Discontinuous | PAN | Preforming | Small | 1,800 C-2,200 C | Up to 150 C/min | 45 MPa-70 MPa |
| Discontinuous | PAN | Preforming | Large | 1,800 C-2,200 C | 20-50 C/min | 45 MPa-70 MPa |

### Graphite

Manufacturing a graphite component (e.g., which may be referred to as a carbon-based component) may include providing a formulation comprising pitch (mesophase or isotropic). The pitch can be ground (e.g., milled) to an average particle size of between approximately 3 microns and approximately 5 microns, or from approximately 1 micron to approximately 10 microns, or from approximately 1 micron to approximately 50 microns, or any value, approximate value, or range of values within the foregoing ranges. The pitch can be coked at 600 °C or approximately 600 °C to be coked, or in a range from 550 °C or approximately 550 °C to 650 °C or approximately 650 °C, or from 500 °C or approximately 500 °C to 700 °C or approximately 700 °C, or from 450 °C or approximately 450 °C to 750 °C or approximately 750 °C, or from 400 °C or approximately 400 °C to 1,000 °C or approximately 1,000 °C or greater than 1,000 °C, or of any value, approximate value, or range of values within any of the foregoing ranges. The coked pitch may help reduce off-gassing and flow out of the die. A formulation for manufacturing graphite may include mesophase pitch and isotropic pitch. The isotropic pitch can be heated at 90 °C or approximately 90 °C, or in a range from 80 °C or approximately 80 °C to 100 °C or approximately 100 °C, or in a range from 70 °C or approximately 70 °C to 110 °C or approximately 110 °C. In some embodiments, a formulation may include 100% mesophase pitch or 100% isotropic pitch. In some embodiments, a formulation may include 95% mesophase pitch and/or 5% isotropic pitch. In some embodiments, a formulation may include 90% mesophase pitch and/or 10% isotropic pitch. In some embodiments, a formulation may include 85% mesophase pitch and/or 15% isotropic pitch. In some embodiments, a formulation may include 80% mesophase pitch and/or 20% isotropic pitch. In some embodiments, a formulation may include 75% mesophase pitch and/or 25% isotropic pitch. In some embodiments, a formulation may include 70% mesophase pitch and/or 30% isotropic pitch. In some embodiments, a formulation may include 65% mesophase pitch and/or 35% isotropic pitch. In some embodiments, a formulation may include 60% mesophase pitch and/or 40% isotropic pitch. In some embodiments, a formulation may include 55% mesophase pitch and/or 45% isotropic pitch. In some embodiments, a formulation may include 50% mesophase pitch and/or 50% isotropic pitch. In some embodiments, a formulation may include 45% mesophase pitch and/or 55% isotropic pitch. In some embodiments, a formulation may include 40% mesophase pitch and/or 60% isotropic pitch. In some embodiments, a formulation may include 35% mesophase pitch and/or 65% isotropic pitch. In some embodiments, a formulation may include 30% mesophase pitch and/or 70% isotropic pitch. In some embodiments, a formulation may include 25% mesophase pitch and/or 75% isotropic pitch. In some embodiments, a formulation may include 20% mesophase pitch and/or 80% isotropic pitch. In some embodiments, a formulation may include 15% mesophase pitch and/or 85% isotropic pitch. In some embodiments, a formulation may include 10% mesophase pitch and/or 90% isotropic pitch. In some embodiments, a formulation may include 5% mesophase pitch and/or 95% isotropic pitch.

In some embodiments, the formulation for manufacturing graphite can include one or more of TiC, B4C, SiC, ZrC, TaC, WC, MoB2, TiB2, ZrB2, TaB2, HfC, and/or HfB2 in the proportions in the table below, or in any value, approximate value, or range of values within the provided range. In some embodiments, the formulation can include milled carbon fibers. For example and without limitation, the formulation can include approximately 1% to approximately 5% milled carbon fibers. In some embodiments, the formulation can include mesophase pitch having a softening point that is greater than 300 °C or approximately 300 °C, or greater than 320 °C or approximately 320 °C, or greater than 340 °C or approximately 340 °C, or greater than 360 °C or approximately 360 °C, or greater than 380 °C or approximately 380 °C. In some embodiments, the formulation can include mesophase pitch having a softening point that is in a range from 340 °C or approximately 340 °C to 360 °C or approximately 360 °C, or from 320 °C or approximately 320 °C to 380 °C or approximately 380 °C, or from 300 °C or approximately 300 °C to 400 °C or approximately 400 °C, or any value, approximate value, or range of values within the foregoing ranges. The formulation can include from 1% or approximately 1% to 5% or approximately 5% of the mesophase pitch having the aforementioned softening points, or from 1% or approximately 1% to 10% or approximately 10% of the mesophase pitch having the aforementioned softening points, or from 1% or approximately 1% to 20% or approximately 20% of the mesophase pitch having the aforementioned softening points or any value, approximate value, or range of values within the foregoing ranges.

In some embodiments, if a formulation includes 100% coked mesophase pitch, the coked mesophase pitch can be loaded directly into a die of a field assisted sintering machine for sintering. In some embodiments, if a formulation includes mesophase pitch or isotropic phase pitch that has not been coked, can then be preformed at a temperature between 350 °C or approximately 350 °C and 420 °C or approximately 420 °C and at a pressure between 3 MPa or approximately 3 MPa and 70 MPa or approximately 70 MPa. The combined materials can be preformed until a tap density between 1.2×-1.4× of final dimensions is achieved for small parts, or between 1.7×-1.9× of final dimensions is achieved for large parts. The preform can then be loaded into a die of a field assisted sintering machine for sintering. The preform can be sintered at a target temperature in a range from 2,400 °C or approximately 2,400 °C to 2,600 °C or approximately 2,600 °C, or from 2,200 °C or approximately 2,200 °C to 2,800 °C or approximately 2,800 °C, or from 2,000 °C or approximately 2,000 °C to 3,000 °C or approximately 3,000 °C. In some embodiments, the target temperature can be greater than 3,000 °C. During sintering, pressure can be applied to the one or more materials between 50 MPa or approximately 50 MPa and 200 MPa or approximately 200 MPa. During sintering, if making a small component, temperature can be increased at a ramp rate of up to 150 °C/minute. If making a larger component, temperature can be increased at a ramp rate of between 20 °C/minute and 50 °C/minute. The preform can be held at the target temperature for a period of time between 30 minutes or approximately 30 minutes and 60 minutes or approximately 60 minutes. After sintering, the part can be post-machined to reach final dimensions. In some embodiments, as an alternative to preforming, the one or more mixed materials can be compacted into sheets using high shear compaction, which can be loaded into a die of a field assisted sintering machine for sintering. The following tables illustrate example formulations, sintering preparations (preforming vs. high shear compaction vs. no preforming), desired sizes of final components, and sintering parameters. These examples are not limiting. The graphite component can be produced in a single preforming step and a single sintering step. The preforming step and the sintering step can each include a single thermal cycle. The graphite component can be produced without repeated infiltration steps. The graphite component can be produced without using resins. The graphite component can be produced without using phenolic resins. The graphite component can be produced without using polymer-infiltration and pyrolysis (PIP). 90%, or at least 95% or approximately 95%, or at least 99% or approximately 99%. The graphite component can have a degree of graphitization of at least 80% or approximately 80%, or at least 85% or approximately 85%, or at least 90% or approximately 90%, or at least 95% or approximately 95%, or at least 99% or approximately 99%. The graphite component can have a degree of graphitization of 80% or approximately 80%, or from 75% or approximately 75% to 85% or approximately 85%, or from 70% or approximately 70% to 90% or approximately 90%, or from 65% or approximately 65% to 99% or approximately 99%, or any value, approximate value, or range of values within the foregoing ranges.

Formulation
0-100% coked mesophase pitch
0-100% coked isotropic phase pitch
0-100% mesophase pitch
0-100% isotropic phase pitch
5-50% TiC, B4C, SiC, ZrC, TaC, WC,
MoB2, TiB2, ZrB2, TaB2, HfC, and/or HfB2
0-45% milled carbon fibers

| | Size of | FAST | FAST | |
|---|---|---|---|---|
| Sintering | Final | Target | Ramp | FAST |
| Prep | Component | Temp | Rate | Pressure |
| Preforming | Small | 2,000 C- | Up to 150 | 50 MPa- |
| | | 3,000 C | C/min | 200 MPa |
| Preforming | Large | 2,000 C- | 20-50 | 50 MPa- |
| | | 3,000 C | C/min | 200 MPa |
| High Shear | Small | 2,000 C- | Up to 150 | 50 MPa- |
| Compaction | | 3,000 C | C/min | 200 MPa |
| High Shear | Large | 2,000 C- | 20-50 | 50 MPa- |
| Compaction | | 3,000 C | C/min | 200 MPa |
| No Preforming | Small | 2,000 C- | Up to 150 | 50 MPa- |
| (load directly | | 3,000 C | C/min | 200 MPa |
| to FAST) | | | | |
| No Preforming | Large | 2,000 C- | 20-50 | 50 MPa- |
| (load directly | | 3,000 C | C/min | 200 MPa |
| to FAST) | | | | |

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations, one or more features from a claimed combination can, in some cases, be excised from the combination, and the combination may be claimed as a sub-combination or variation of a sub-combination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. May be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within 10% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A method for manufacturing a carbon-based component using field assisted sintering technology, the method comprising:
providing a powder comprising mesophase pitch and a plurality of milled carbon fibers;
combining the powder with a plurality of carbon fibers;
creating a preform from the combined powder and plurality of carbon fibers by heating the combined powder and plurality of carbon fibers;
loading the preform into a field assisted sintering machine; and
sintering, via the field assisted sintering machine, the preform by applying electric current and pressure to the preform to create the carbon-based component.

2. The method of claim 1, wherein the carbon-based component has a density of at least 90% of a theoretical density.

3. The method of claim 1, wherein the mesophase pitch has a softening point between approximately 300 °C and approximately 400 °C.

4. The method of claim 1, wherein the mesophase pitch comprises approximately 10% to approximately 35% of a volume of the combined powder and plurality of carbon fibers, the plurality of carbon fibers comprise approximately 40% to approximately 55% of the volume, and the plurality of milled fibers comprise approximately 10% to approximately 45% of the volume.

5. The method of claim 1, wherein creating the preform comprises heating the combined powder and plurality of carbon fibers to a target temperature between approximately 350 °C and approximately 450 °C.

6. The method of claim 1, wherein creating the preform comprises applying a pressure of between approximately 1 MPa and approximately 20 MPa during heating.

7. The method of claim 4, wherein creating the preform comprises loading the combined powder and plurality of carbon fibers into a hot press.

8. The method of claim 1, wherein sintering the preform comprises heating the preform to a target temperature of between approximately 1,800 °C and approximately 2,200 °C.

9. The method of claim 1, wherein sintering the preform comprises applying a pressure of between approximately 20 MPa and approximately 70 MPa to the preform.

10. The method of claim 2, wherein the density is at least 95% of the theoretical density.

11. The method of claim 1, wherein the plurality of milled carbon fibers have lengths between approximately 100 microns and 200 microns.

12. The method of claim 1, wherein the plurality of carbon fibers comprise chopped carbon fibers have lengths between approximately 0.125 inches and approximately 2 inches.

13. The method of claim 1, wherein the plurality of carbon fibers comprise unidirectional carbon fiber.

14. The method of claim 1, wherein the plurality of carbon fibers comprise two-dimensional woven carbon fiber.

15. The method of claim 1, wherein the plurality of carbon fibers comprise chopped carbon fibers having lengths between approximately 0.125 inches and approximately 2 inches, and unidirectional carbon fiber.

16. The method of claim 1, further comprising applying tape to the preform, and wherein sintering the preform comprises sintering the tape and the preform.

17. The method of claim 1, wherein the carbon-based component is produced without repeated infiltration and pyrolysis cycles.

18. The method of claim 1, wherein the carbon-based component is produced without using phenolic resins.

19. The method of claim 1, wherein the powder further comprises one or more of silicon carbide and zirconium diboride.

20. A method of manufacturing a carbon-based component using field assisted sintering technology, comprising:
providing a powder comprising mesophase pitch;
heating and applying pressure to the powder to create a preform;
loading the preform into a field assisted sintering machine; and
sintering, via the field assisted sintering machine, the preform by applying electric current and pressure to the preform to create the carbon-based component,
wherein the carbon-based component has a density of at least 90% of a theoretical density.

21. The method of claim 20, wherein the mesophase pitch is at least partially coked.

22. The method of claim 20, wherein the mesophase pitch is coked at approximately 800 °C.

23. The method of claim 20, wherein the powder comprises an average particle size of approximately 1 micron to approximately 50 microns.

24. The method of claim 20, wherein creating the preform comprises heating the powder to a target temperature between approximately 350 °C and approximately 450 °C.

25. The method of claim 20, wherein creating the preform comprises applying a pressure of between approximately 1 MPa and approximately 20 MPa during heating.

26. The method of claim 20, wherein sintering the preform comprises heating the preform to a target temperature of between approximately 2,000 °C and approximately 3,000 °C.

27. The method of claim 20, wherein the carbon-based component is produced without repeated infiltration and pyrolysis cycles.
